(19) United States
(12) Patent Application Publication
(10) Pub. No.: US 2013/0039485 A1
(43) Pub. Date: Feb. 14, 2013

(54) INFORMATION PROCESSING SYSTEM, REPRODUCING DEVICE, INFORMATION PROCESSING DEVICE, INFORMATION PROCESSING METHOD, AND PROGRAM

(71) Applicants: Kenjiro UEDA, Kanagawa (JP); Hiroshi KUNO, Kanagawa (JP); Takamichi HAYASHI, Tokyo (JP)

(72) Inventors: Kenjiro UEDA, Kanagawa (JP); Hiroshi KUNO, Kanagawa (JP); Takamichi HAYASHI, Tokyo (JP)

(73) Assignee: Sony Corporation, Tokyo (JP)

(21) Appl. No.: 13/547,690

(22) Filed: Jul. 12, 2012

(30) Foreign Application Priority Data
Aug. 11, 2011 (JP) 2011-175608

(51) Int. Cl. G06F 21/24

(52) U.S. Cl. 380/28

(57) ABSTRACT

An information processing system includes a medium storing contents for reproduction, and a reproducing device to reproduce the contents. The reproducing device obtains a device certificate and transmits the device certificate to the medium. The device certificate includes the reproducing device's type information, and the medium encodes a media ID for identifying the medium according to an encoding algorithm selected according to the reproducing device's type information. The encoded media ID is transmitted to the reproducing device, which decodes the encoded media ID according to a decoding algorithm corresponding to the device type of the reproducing device, and decrypts and reproduces data to which the obtained media ID is applied.

### BACKGROUND

The present disclosure relates to an information processing system, a reproducing device, an information processing device, an information processing method, and a program, and particularly to an information processing system, a reproducing device, an information processing device, an information processing method, and a program that effectively prevent illegal use of contents recorded on a recording medium such as a memory card, for example.

Nowadays, various media such as a DVD (Digital Versatile Disc), a Blu-ray Disc (registered trademark), a flash memory, and the like are used as information recording media. Memory cards such for example as USB (Universal Serial Bus) memories including high-capacity flash memories, in particular, are growing in use nowadays. Users can record contents such as music, movies, and the like on such various information recording media, load the information recording media into a reproducing device (player), and reproduce the contents.

However, creators or distributors of many contents such as music data, image data, and the like reserve copyrights on the contents, distribution rights to the contents, and the like. Thus, when contents are provided to users, it is common practice to impose a certain use limitation, that is, permit only users having a legitimate right to use the contents, and perform control so as to prevent lawless use such as copying without permission and the like.

For example, AACS (Advanced Access Content System) is known as a standard relating to content use control. The AACS standard defines a use control configuration for contents recorded on the Blu-ray Disc (registered trademark), for example. Specifically, the AACS standard for example specifies an algorithm that makes it possible to make contents recorded on the Blu-ray Disc (registered trademark) encrypted contents and limit users who can obtain a cryptographic key to the encrypted contents to only authorized users.

However, the current AACS specifications include specifications about a use control configuration for contents recorded on disks such as the Blu-ray Disc (registered trademark) and the like, but do not include sufficient specifications for contents and the like recorded on flash memories such as memory cards, for example. Thus, copyrights on contents recorded on such memory cards may be protected insufficiently, and there has been a request for the construction of a use control configuration for content use using media such as these memory cards and the like.

The AACS specifications for example include the following specifications as a use control configuration for contents recorded on disks such as the Blu-ray Disc (registered trademark) and the like:
(a) a use specification for contents copied from a medium on which contents are already recorded (for example a ROM disk) to a disk such as the Blu-ray Disc (registered trademark) or the like; and
(b) a use specification for contents downloaded from a server and recorded onto a disk such as the Blu-ray Disc (registered trademark) or the like.

The AACS specifications for example specify control of use of such contents.

ARCS specifies a managed copy (MC) on condition that copy allowance information is obtained from a managing server when contents are copied between the media in the case of the above (a), for example.

In addition, AACS defines the following various forms of downloading as processes of downloading contents from the server in the case of the above (b):
EST (Electric Sell Through) using a user device such as a PC or the like; and
MoD (Manufacturing on Demand) using a shared terminal installed in a convenience store or the like.

AACS requires that a process be performed according to a predetermined rule also when contents are recorded onto a disk by each of these downloading processes and then used.

Incidentally, these processes are described in Japanese Patent Laid-Open No. 2008-98765, for example.

However, as described above, the AACS specifications assume contents recorded on disks such as the Blu-ray Disc (registered trademark) and the like as objects of use control, and do not include sufficient specifications relating to control of use of contents recorded on memory cards of a flash memory type and the like including USB memories.

### SUMMARY

The present disclosure has been made in view of the above problems. It is desirable to provide an information processing device, an information processing method, and a program that establish a use control configuration in cases where contents are recorded onto information recording media such as a flash memory and the like and then used, and which realize a constitution for preventing illegal use of the contents.

According to a first embodiment of the present disclosure, there is provided an information processing system including: a medium for storing contents as an object of reproduction; and a reproducing device configured to reproduce the contents stored on the medium. In the information processing system, the reproducing device obtains a device certificate stored in a storage section and transmits the device certificate to the medium, reproducing device type information indicating a device type of the reproducing device is recorded in the device certificate, the medium encodes a media ID as information for identifying the medium according to an encoding algorithm selected according to the reproducing device type information recorded in the device certificate, and transmits the encoded media ID to the reproducing device, and the reproducing device decodes the encoded media ID received from the medium according to a decoding algorithm corresponding to the device type of the reproducing device, and performs content decryption and reproduction involving data processing to which the obtained media ID is applied.

Further, in one embodiment of the information processing system according to the present disclosure, the reproducing device decodes the encoded media ID received from the medium according to the decoding algorithm corresponding to the device type of the reproducing device, calculates a verification value based on the obtained media ID, performs a comparing and verifying process between the calculated verification value and a verification value for reference, the verification value for reference having been obtained from the medium, and decrypts and reproduces the contents stored on the medium on condition that verification is established.

Further, in one embodiment of the information processing system according to the present disclosure, the reproducing device calculates the verification value based on the media ID by data processing to which a cryptographic key applied to decryption of encrypted contents stored on the medium is applied.

Further, in one embodiment of the information processing system according to the present disclosure, the medium stores a cryptographic key applied to decryption of the contents in a protected area allowed to be accessed on a basis of confirmation of an access right of the reproducing device, and the medium confirms the access right to the protected area storing the cryptographic key on a basis of protected area access right information recorded in the device certificate received from the reproducing device, and allows the cryptographic key to be read by the reproducing device when the access right of the reproducing device is confirmed.

Further, in one embodiment of the information processing system according to the present disclosure, the reproducing device transmits the obtained device certificate to the medium, and performs an authentication process, and the medium determines whether to allow a cryptographic key reading request from the reproducing device on condition that the authentication process is established.

Further, according to a second embodiment of the present disclosure, there is provided a reproducing device configured to read and reproduce contents stored on a medium. In the reproducing device, a data processing section obtains a device certificate in which reproducing device type information indicating a device type of the reproducing device is recorded from a storage section, and transmits the obtained device certificate to the medium, the data processing section receives an encoded media ID obtained by encoding a media ID as information for identifying the medium from the medium, decodes the received encoded media ID, and performs content decryption and reproduction involving data processing to which the obtained media ID is applied. The encoded media ID is data encoded by the medium according to an encoding algorithm selected according to the reproducing device type information recorded in the device certificate, and the data processing section decodes the encoded media ID according to a decoding algorithm corresponding to the device type of the reproducing device.

Further, in one embodiment of the reproducing device according to the present disclosure, the data processing section decodes the encoded media ID received from the medium according to the decoding algorithm corresponding to the device type of the reproducing device, calculates a verification value based on the obtained media ID, performs a comparing and verifying process between the calculated verification value and a verification value for reference, the verification value for reference having been obtained from the medium, and decrypts and reproduces the contents stored on the medium on condition that verification is established.

Further, in one embodiment of the reproducing device according to the present disclosure, the data processing section calculates a verification value based on the media ID by data processing to which a cryptographic key applied to decryption of encrypted contents stored on the medium is applied.

Further, in one embodiment of the reproducing device according to the present disclosure, the medium stores a cryptographic key applied to decryption of the contents in a protected area allowed to be accessed on a basis of confirmation of an access right of the reproducing device, and the data processing section supplies the device certificate in which information on an access right to the protected area is recorded to the medium, and reads the cryptographic key on condition that the access right to the protected area is confirmed by the medium.

Further, in one embodiment of the reproducing device according to the present disclosure, the data processing section transmits the device certificate to the medium, and performs an authentication process, and the data processing section reads the cryptographic key applied to the decryption of the contents on condition that the authentication process is established with the medium.

Further, according to a third embodiment of the present disclosure, there is provided an information processing device including: a storage section configured to store encrypted contents as an object of reproduction in a reproducing device and a cryptographic key to be applied to decryption of the encrypted contents; and a data processing section. In the information processing device, the data processing section receives a device certificate in which reproducing device type information indicating a device type of the reproducing device is recorded from the reproducing device, and the data processing section generates an encoded media ID by encoding a media ID as information for identifying the information processing device according to an encoding algorithm selected according to the reproducing device type information recorded in the device certificate, and transmits the encoded media ID to the reproducing device.

Further, in one embodiment of the information processing device according to the present disclosure, the data processing section transmits the encoded media ID and a verification value for reference, the verification value for reference having been generated on a basis of the media ID, to the reproducing device.

Further, in one embodiment of the information processing device according to the present disclosure, the storage section has a protected area allowed to be accessed on a basis of confirmation of an access right of the reproducing device, and the cryptographic key is stored in the protected area, and the data processing section confirms the access right to the protected area storing the cryptographic key on a basis of protected area access right information recorded in the device certificate received from the reproducing device, and allows the cryptographic key to be read by the reproducing device when the access right of the reproducing device is confirmed.

Further, according to a fourth embodiment of the present disclosure, there is provided an information processing method performed in an information processing system, the information processing system including a medium for storing contents as an object of reproduction and a reproducing device configured to reproduce the contents stored on the medium, the information processing method including: the reproducing device obtaining a device certificate in which reproducing device type information indicating a device type of the reproducing device is recorded from a storage section and transmitting the device certificate to the medium; the medium encoding a media ID as information for identifying the medium according to an encoding algorithm selected according to the reproducing device type information recorded in the device certificate, and transmitting the encoded media ID to the reproducing device; and the reproducing device decoding the encoded media ID received from the medium according to a decoding algorithm corresponding to the device type of the reproducing device, and performing content decryption and reproduction involving data processing to which the obtained media ID is applied.

Further, according to a fifth embodiment of the present disclosure, there is provided an information processing method for reading and reproducing contents stored on a medium in a reproducing device, the information processing method including: a data processing section obtaining a device certificate in which reproducing device type information indicating a device type of the reproducing device is recorded from a storage section, and transmitting the obtained device certificate to the medium; the data processing section receiving an encoded media ID obtained by encoding a media ID as information for identifying the medium from the medium, decoding the received encoded media ID, and performing content decryption and reproduction involving data processing to which the obtained media ID is applied; the encoded media ID being data encoded by the medium according to an encoding algorithm selected according to the reproducing device type information recorded in the device certificate; and the data processing section decoding the encoded media ID according to a decoding algorithm corresponding to the device type of the reproducing device.

Further, according to a sixth embodiment of the present disclosure, there is provided an information processing method performed in an information processing device, the information processing device including a storage section configured to store encrypted contents as an object of reproduction in a reproducing device and a cryptographic key to be applied to decryption of the encrypted contents, and a data processing section, the information processing method including: the data processing section receiving a device certificate in which reproducing device type information indicating a device type of the reproducing device is recorded from the reproducing device; and the data processing section generating an encoded media ID by encoding a media ID as information for identifying the information processing device according to an encoding algorithm selected according to the reproducing device type information recorded in the device certificate, and transmitting the encoded media ID to the reproducing device.

Further, according to a seventh embodiment of the present disclosure, there is provided a program for making a reproducing device read and reproduce contents stored on a medium, the program including: making a data processing section obtain a device certificate in which reproducing device type information indicating a device type of the reproducing device is recorded from a storage section, and transmit the obtained device certificate to the medium; making the data processing section receive an encoded media ID obtained by encoding a media ID as information for identifying the medium from the medium, decode the received encoded media ID, and perform content decryption and reproduction involving data processing to which the obtained media ID is applied; the encoded media ID being data encoded by the medium according to an encoding algorithm selected according to the reproducing device type information recorded in the device certificate; and making the data processing section decode the encoded media ID according to a decoding algorithm corresponding to the device type of the reproducing device.

Further, according to an eighth embodiment of the present disclosure, there is provided a program for making an information processing device perform information processing, the information processing device including a storage section configured to store encrypted contents as an object of reproduction in a reproducing device and a cryptographic key to be applied to decryption of the encrypted contents, and a data processing section, the program including: making the data processing section receive a device certificate in which reproducing device type information indicating a device type of the reproducing device is recorded from the reproducing device; and making the data processing section generate an encoded media ID by encoding a media ID as information for identifying the information processing device according to an encoding algorithm selected according to the reproducing device type information recorded in the device certificate, and transmit the encoded media ID to the reproducing device.

Incidentally, the programs according to the above-described embodiments of the present disclosure are for example programs that can be provided by a storage medium provided in a computer-readable format or a communication medium to an information processing device or a computer system capable of executing various program codes. Such a program is provided in a computer-readable format, whereby a process corresponding to the program is realized on the information processing device or the computer system.

Other and further objects, features, and advantages of the present disclosure will become apparent from more detailed description on the basis of embodiments of the present disclosure and the accompanying drawings to be described later. Incidentally, a system in the present specification is a logical set configuration of a plurality of devices, and is not limited to a system in which the devices of respective configurations are within an identical casing.

According to the configuration of one embodiment of the present disclosure, a device or a method for controlling the use of contents according to the type of a reproducing device configured to reproduce the contents stored on a medium is realized.

Specifically, a device certificate in which the type of a reproducing device configured to reproduce contents stored on a medium, for example a device type indicating a reproduction only device such as a BD player, a PC, or the like, is recorded is provided from the reproducing device to the medium. The data processing section of the medium checks device type information recorded in the device certificate, encodes a media ID by selecting and applying a different encoding algorithm according to the device type, and then provides the encoded media ID to the reproducing device. The reproducing device decodes the encoded media ID by a decoding algorithm corresponding to the type of the device itself. Only when the decoding has succeeded, and the media ID can be obtained, the contents can be decrypted and reproduced. Content use control according to the type of the reproducing device is realized by these processes.

### BRIEF DESCRIPTION OF THE DRAWINGS

FIG. 1 is a diagram of assistance in explaining an outline of a content providing process and a content using process;

FIG. 2 is a diagram of assistance in explaining forms of use of contents recorded on a memory card;

FIG. 3 is a diagram of assistance in explaining a concrete example of configuration of a storage area of the memory card;

FIG. 4 is a diagram of assistance in explaining a host certificate (Host Certificate);

FIG. 5 is a diagram of assistance in explaining the concrete example of configuration of the storage area of the memory card and an example of access control processes;

FIG. 6 is a diagram of assistance in explaining an example of data stored on the memory card;

FIGS. 7A and 7B are diagrams of assistance in explaining an example of data configuration of host certificates (Host Certificates) in which device types and type information on corresponding content types are recorded;

FIG. 8 is a diagram of assistance in explaining a concrete example of device types and type information on corresponding content types recorded in the host certificates (Host Certificates);

FIG. 9 is a flowchart of assistance in explaining a content use sequence performed by selecting and starting a reproducing program according to a content type and using a host certificate (Host Cert) associated with the started reproducing program;

FIG. 10 is a flowchart of assistance in explaining the content use sequence performed by selecting and starting the reproducing program according to the content type and using the host certificate (Host Cert) associated with the started reproducing program;

FIG. 11 is a flowchart of assistance in explaining the content use sequence performed by selecting and starting the reproducing program according to the content type and using the host certificate (Host Cert) associated with the started reproducing program;

FIG. 12 is a flowchart of assistance in explaining a sequence in which a reproducing program selects and uses a host certificate (Host Cert) according to a content type;

FIG. 13 is a flowchart of assistance in explaining the sequence in which the reproducing program selects and uses the host certificate (Host Cert) according to the content type;

FIG. 14 is a flowchart of assistance in explaining the sequence in which the reproducing program selects and uses the host certificate (Host Cert) according to the content type;

FIG. 15 is a diagram of assistance in explaining an example of data stored on a memory card;

FIG. 16 is a diagram of assistance in explaining a content decrypting and reproducing sequence using a media ID (MID);

FIG. 17 is a diagram of assistance in explaining processes in which a mode of conversion of a media ID (MID) is changed according to the type of a host (reproducing device);

FIG. 18 is a diagram of assistance in explaining a content decrypting and reproducing process in a case where a mode of conversion of a media ID (MID) is changed according to the type of a host (reproducing device);

FIG. 19 is a flowchart of assistance in explaining a process sequence in a case where the content decrypting and reproducing process is performed with the mode of conversion of the media ID (MID) changed according to the type of the host (reproducing device);

FIG. 20 is a flowchart of assistance in explaining the process sequence in the case where the content decrypting and reproducing process is performed with the mode of conversion of the media ID (MID) changed according to the type of the host (reproducing device);

FIG. 21 is a flowchart of assistance in explaining the process sequence in the case where the content decrypting and reproducing process is performed with the mode of conversion of the media ID (MID) changed according to the type of the host (reproducing device);

FIG. 22 is a diagram of assistance in explaining an example of hardware configuration of a host (reproducing device); and

FIG. 23 is a diagram of assistance in explaining an example of hardware configuration of a memory card.

### DETAILED DESCRIPTION OF THE PREFERRED EMBODIMENTS

Details of an information processing device, an information processing method, and a program according to embodiments of the present disclosure will hereinafter be described with reference to the drawings. Incidentally, description will be made according to the following headings.
1. Outlines of Content Providing Process and Content Using Process
2. Example of Configuration of Memory Card and Example of Use of Memory Card
3. Certificate Having Access Allowance Information for Protected Area
4. Example of Process of Access to Memory Card to which Certificates of Respective Devices are Applied
5. Example of Process between Host (Reproducing Device) and Medium (Memory Card)
5-1. (First Embodiment) Example of Process between Host and Medium Using Device Certificate Corresponding to Content Type
5-2. (Second Embodiment) Example of Process in which Reproducing Program Selects Device Certificate to be Applied
5-3. (Third Embodiment) Example of Process in which Mode of Conversion of Identifier (Media ID) of Medium (Memory Card) is Changed according to Type of Reproducing Device
6. Example of Hardware Configuration of Each Device
7. Summary of Configurations according to Embodiments of Present Disclosure

### 1. Outlines of Content Providing Process and Content Using Process

Details of an information processing device, an information processing method, and a program according to embodiments of the present disclosure will hereinafter be described with reference to the drawings.

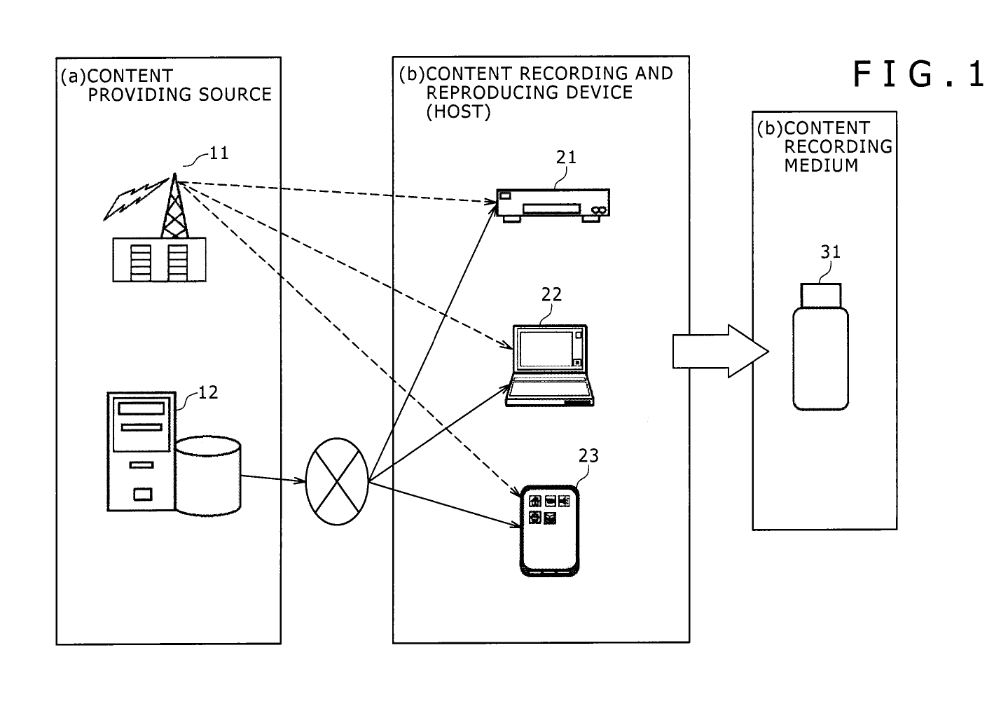

Outlines of a content providing process and a content using process will be described below with reference to FIG. 1 and subsequent figures.

FIG. 1 shows examples of the following from a left:
(a) a content providing source;
(b) a content recording and reproducing device (host); and
(c) a content recording medium.

The content recording medium is a medium on which a user records contents, and which the user uses in a process of reproducing the contents. In this case, a memory card 31, which is an information recording device such as a flash memory, for example, is shown as the content recording medium.

The user records and uses various contents such for example as music and movies on the memory card 31. The contents include contents as an object of usage control such for example as contents as an object of copyright management.

The contents as an object of usage control are for example contents lawless copying of which is prohibited or whose copy data is prohibited from being distributed. Incidentally, when usage-controlled contents are recorded on the memory card 31, usage control information (usage rule) corresponding to the contents, or specifically usage control information (usage rule) specifying copy limiting information such as an allowed number of times of copying and the like, is also recorded.

The content providing source is a source that provides contents such as music, movies, and the like. FIG. 1 shows a broadcasting station 11 and a content server 12 as an example of the content providing source.

The broadcasting station 11 is for example a television station. The broadcasting station 11 provides various broadcast contents to a user device [(b) a content recording and reproducing device (host)] on ground waves or satellite waves via a satellite.

The content server 12 is a server that provides contents such as music, movies, and the like via a network such as the Internet or the like.

The user can for example load the memory card 31 as a content recording medium into a content recording and reproducing device (host), receive contents provided by the broadcasting station 11 or the content server 12 via a receiving section of the content recording and reproducing device (host) itself or a receiving device connected to the content recording and reproducing device (host), and record the contents onto the memory card 31.

The content recording and reproducing device (host) is loaded with the memory card 31 as a content recording medium, and records the contents received from the broadcasting station 11 or the content server 12 as a content providing source onto the memory card 31.

The content recording and reproducing device (host) includes a recording and reproduction only device (CE device: Consumer Electronics Device) 21 such as a DVD player, for example, which device has a hard disk and a disk such as a DVD, a BD, or the like. The content recording and reproducing device (host) further includes for example a PC 22 and a portable terminal 23 such as a smart phone, a portable telephone, a portable player, a tablet terminal, or the like. All of these devices can be loaded with the memory card 31 as a content recording medium.

The user receives contents such as music, movies, and the like from the broadcasting station 11 or the content server 12 using the recording and reproduction only device 21, the PC 22, the portable terminal 23, or the like, and records the contents onto the memory card 31.

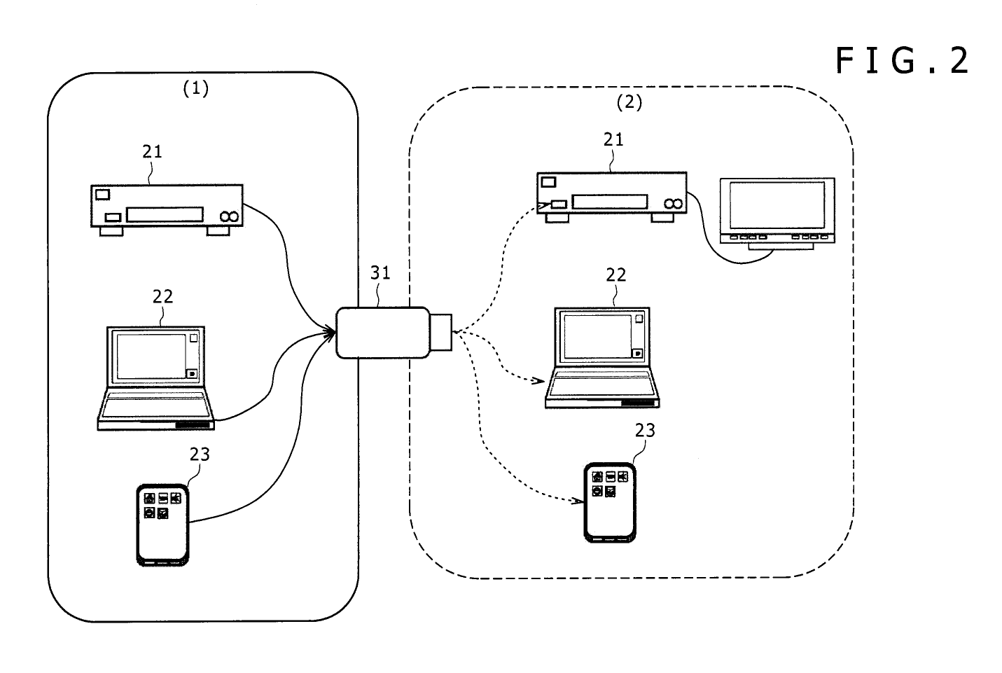

Forms of use of contents recorded on the memory card 31 will be described with reference to FIG. 2.

The memory card 31 is a recording medium that can be inserted into and detached from a content reproducing device such as a PC, for example. The memory card 31 can be freely removed from a device that has recorded contents onto the memory card 31, and can be loaded into another user device.

Specifically, as shown in FIG. 2, it is not essential that the following processes be performed by an identical device:
(1) a recording process; and
(2) a reproducing process.

The user can freely select and use a recording device and a reproducing device.

Incidentally, in many cases, usage-controlled contents recorded on the memory card 31 are recorded as encrypted contents. A content reproducing device such as the recording and reproduction only device 21, the PC 22, the portable terminal 23, or the like performs a decrypting process according to a predetermined sequence, and thereafter reproduces the contents.

### 2. Example of Configuration of Memory Card and Example of Use of Memory Card

Description will next be made of an example of configuration of the memory card such as a flash memory or the like used as a content recording medium and an example of use of the memory card.

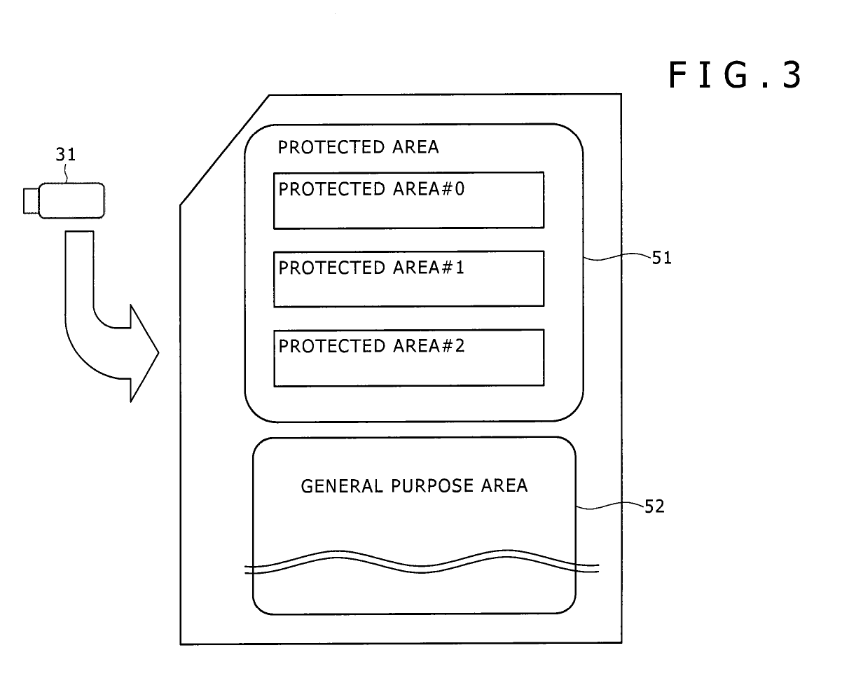

FIG. 3 shows a concrete example of configuration of a storage area of the memory card 31.

As shown in FIG. 3, the storage area of the memory card 31 is formed by the following two areas:
(a) a protected area 51; and
(b) a general purpose area 52.

The general purpose area 52 is an area freely accessible by a recording and reproducing device used by the user. Contents, ordinary content management data, and the like are recorded in the general purpose area 52. The general purpose area 52 is for example an area in which a server or the recording and reproducing device of the user can freely write and read data.

On the other hand, the protected area 51 is an area that does not allow free access thereto.

For example, when data is to be written or read by the recording and reproducing device used by the user, the server connected via a network, or the like, a data processing section of the memory card 31 determines according to a program stored on the memory card 31 in advance whether the reading (Read) or the writing (Write) is possible or not according to each device.

The memory card 31 includes the data processing section configured to execute the program stored in advance and an authentication process section configured to perform an authentication process. The memory card 31 first performs an authentication process with the device intended to write or read data on the memory card 31.

In a stage of the authentication process, a device certificate such as a public key certificate or the like is received from the other device, that is, an access requesting device.

When the access requesting device is a server, for example, a server certificate retained by the server is received, and whether access to each divided area of the protected area 51 is allowed is determined using information described in the certificate.

When the access requesting device is a host device, or for example a recording and reproducing device (host) as a user device performing content recording and reproduction, a host certificate retained by the recording and reproducing device (host) is received, and whether access to each divided area of the protected area 51 is allowed is determined using information described in the certificate.

This access right determining process is performed in units of divided areas (areas #0, #1, #2, . . . shown in FIG. 3) within the protected area 51 shown in FIG. 3. The memory card 31 allows only an allowed process (process such as data reading/writing or the like) in an allowed divided area, and allows the server or the host to perform the process.

Reading/writing limiting information (PAD Read/PAD Write) for the medium is for example set in a unit of a device intended to make access, for example a content server, or a recording and reproducing device (host). These pieces of information are recorded in the server certificate and the host certificate corresponding to the respective devices.

Incidentally, “certificate” will be abbreviated to “cert” in the following.

Thus, according to the specified program stored on the memory card 31 in advance, the memory card 31 verifies the recorded data of the server certificate (Server Cert) and the host certificate (Host Cert), and allows access to only an area allowed to be accessed.

### 3. Certificate Having Access Allowance Information for Protected Area

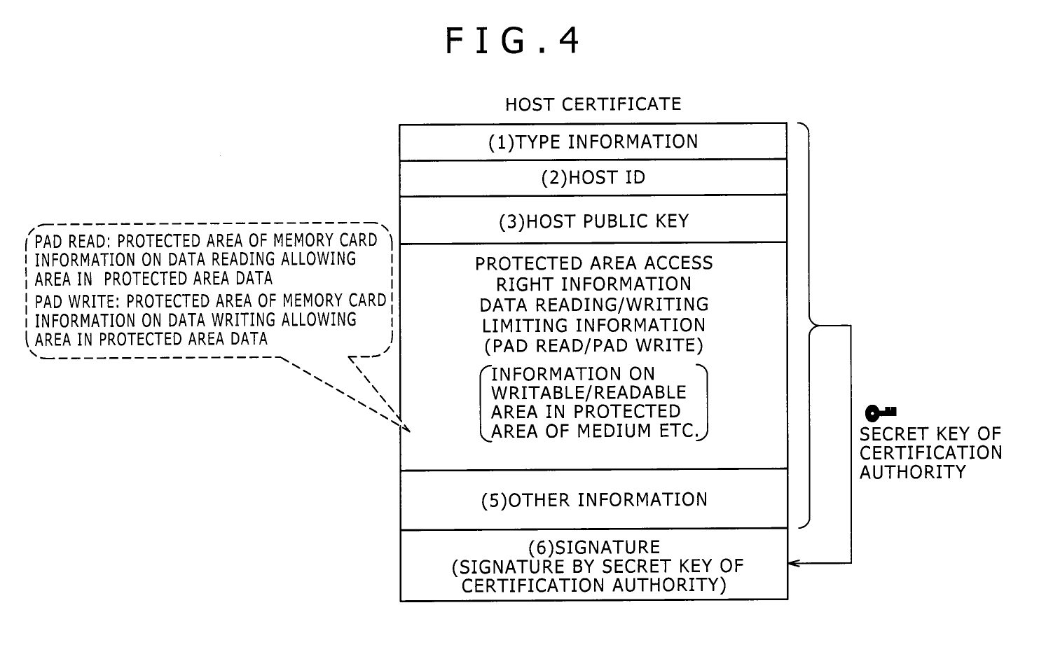

Referring to FIG. 4, description will next be made of an example of configuration of a certificate that needs to be presented to the memory card when the protected area 51 of the memory card 31 described above is to be accessed.

As described above, the memory card 31 performs an authentication process with a device intended to write or read data on the memory card 31. In a state of the authentication process, a device certificate such as a public key certificate or the like (for example a server certificate (Server Cert) or a host certificate (Host Cert)) is received from the other device, that is, the access requesting device, and whether access to each divided area of the protected area 51 is allowed is determined using information described in the certificate.

Referring to FIG. 4, description will be made of an example of configuration of a host certificate (Host Cert) stored in a user device (host device) such as the recording and reproduction only device 21, the PC 22, or the portable terminal 23 shown in FIG. 1, as an example of a device certificate used for the authentication process.

A host certificate (Host Cert) is for example provided to each user device (host device) by a certification authority, which is a public key certificate issuing entity. For example, a host certificate (Host Cert) is a user device certificate issued to a user device (host device) whose content use process is authorized by the certification authority, and is a certificate having a public key and the like stored therein. A signature is set to the host certificate (Host Cert) by a secret key of the certification authority, and the host certificate (Host Cert) is configured as data protected from being tampered with.

Incidentally, the device certificate can be for example stored in a memory within the device in advance on the basis of device confirmation for a device type and the like at a time of manufacturing of the device. When the device certificate is obtained after purchase by a user, a process of confirming a device type, a type of useable contents, and the like according to a predetermined sequence may be performed between the device and the certification authority or another controlling agency, and the device certificate may be issued to the device and stored in a memory within the device.

Incidentally, a server making access to the protected area of the memory card 31 retains a server certificate (Server Cert) that has a similar configuration to that of the host certificate and in which a server public key and memory card access allowance information are recorded.

FIG. 4 shows a concrete example of the host certificate (Host Cert) provided to each host device (user device) by the certification authority.

As shown in FIG. 4, the host certificate (Host Cert) includes the following data.
(1) type information
(2) host ID (user device ID)
(3) host public key
(4) protected area access right information (reading/writing limiting information (PAD Read/PAD Write) for the protected area of the medium)
(5) other information
(6) signature

The respective pieces of data of the above (1) to (6) will be described in the following.

### (1) Type Information

Type information is information indicating a type of certificate and a type of user device. For example, data indicating that the present certificate is a host certificate and information indicating a type of device, for example a PC or a music reproducing player, are recorded as the type information.

### (2) Host ID

A host ID is an area in which a device ID as device identifying information is recorded.

### (3) Host Public Key

A host public key is the public key of the host device. The host public key forms a key pair conforming to a public key cryptosystem together with a secret key provided to the host device (user device).

### (4) Protected Area Access Right Information (Reading/Writing Limiting Information (PAD Read/PAD Write) for the Protected Area of the Medium)

Information on divided areas allowing data reading (Read) and writing (Write) within the protected area (PDA: Protected Area) 51 set in the storage area of the medium having contents recorded thereon, for example the memory card 31 shown in FIG. 3, is recorded as protected area access right information.

### (5) Other Information and (6) Signature

Various information other than that of the above (1) to (4) is recorded in the host certificate, and signature data for the information of (1) to (5) is recorded in the host certificate.

The signature is given by the secret key of the certification authority. When information recorded in the host certificate, for example the host public key, is extracted and used, a signature verifying process to which the public key of the certification authority is applied is first performed to confirm that the host certificate is not tampered with, and the data stored in the certificate such as the host public key and the like is used on condition that the confirmation is made.

Incidentally, FIG. 4 shows the host certificate in which user device (host device) access allowance information for the protected area of the memory card is recorded. A server that needs to access the protected area, such for example as a content providing server for providing contents to the memory card, is provided with a certificate [server certificate (for example a public key certificate storing a server public key)] in which access allowance information for the protected area of the memory card is recorded as in the host certificate shown in FIG. 4.

### 4. Example of Process of Access to Memory Card to which Certificates of Respective Devices are Applied

As described with reference to FIG. 4, when the protected area 51 of the memory card 31 is to be accessed, a certificate as shown in FIG. 4 needs to be presented to the memory card.

The memory card checks the certificate shown in FIG. 4 to determine whether access to the protected area 51 of the memory card 31 shown in FIG. 3 is possible or not.

The host device retains the host certificate described with reference to FIG. 4. The server for providing contents and the like retains the certificate corresponding to the server (server certificate).

When these devices are to access the protected area of the memory card, the certificates retained by the respective devices need to be provided to the memory card so that the memory card determines whether the access is possible or not on the basis of verification on the side of the memory card.

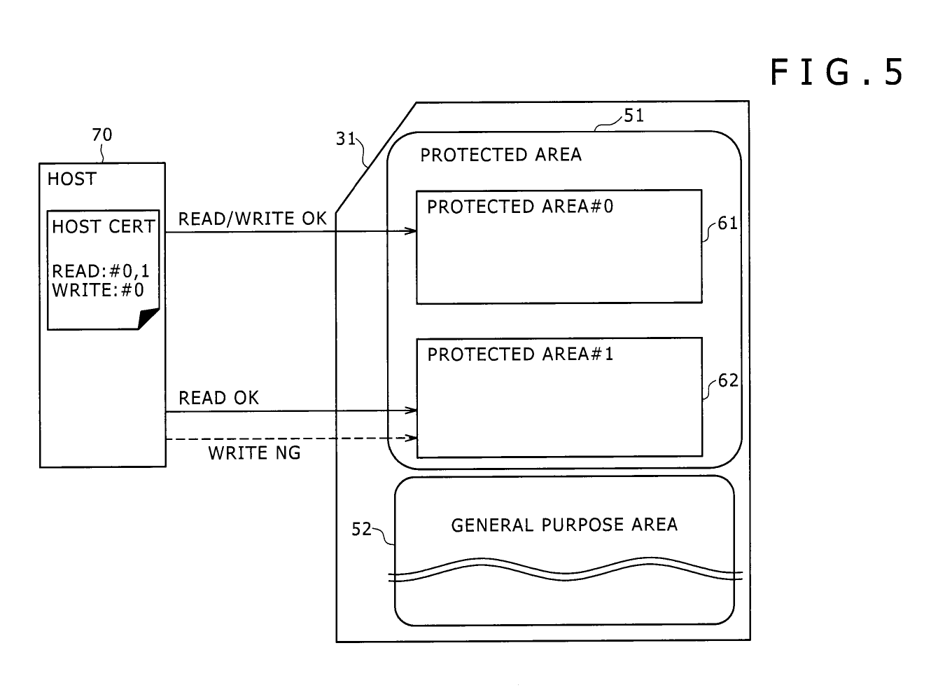

Referring to FIG. 5, description will be made of an example of setting an access limitation in a case where a device requesting access to the memory card is a host device such as a recording and reproducing device or the like.

FIG. 5 shows, from a left, a host (recording and reproducing device) 70 as a device requesting access to the memory card and the memory card 31.

The host (recording and reproducing device) 70 is for example a user device such as the recording and reproduction only device 21, the PC 22, or the portable terminal 23 shown in FIG. 1, and is a device configured to record contents onto the memory card 31 and reproducing contents recorded on the memory card 31.

When the host (recording and reproducing device) 70 outputs contents received from a broadcasting station or a server or contents stored in the storage section of the device itself to the memory card 31 and records the contents onto the memory card 31, the host (recording and reproducing device) 70 writes a title key applied to encryption and decryption of the contents or encrypted or converted data of the title key to the protected area 51 of the memory card 31.

In addition, when the host (recording and reproducing device) 70 uses and reproduces encrypted contents recorded on the memory card 31, the host (recording and reproducing device) 70 obtains the title key or the encrypted or converted data of the title key written in the protected area 51 of the memory card 31.

The host (recording and reproducing device) 70 thus needs to access the protected area 51 of the memory card 31 in a content recording and reproducing process.

The memory card 31 has the protected area 51 and the general purpose area 52. Encrypted contents and the like are recorded in the general purpose area 52.

A title key as a key necessary at a time of reproduction of the contents is recorded in the protected area 51.

As described earlier with reference to FIG. 3, the protected area 51 is divided into a plurality of areas.

In the example shown in FIG. 5, the protected area 51 has the following two divided areas:
a divided area #0 (Protected Area #0) 61; and
a divided area #1 (Protected Area #1) 62.

Various settings can be made as setting modes in these divided areas.

FIG. 5 shows the protected area access right information of the host certificate (Host Cert) retained by the host (recording and reproducing device) 70.

The following settings are made in the access control information of the host certificate shown in FIG. 5:
the divided area #0 (Protected Area #0) allows both of a data recording (Write) process and a data reading (Read) process; and
the divided area #1 (Protected Area #1) allows only a reading (Read) process.

The host certificate (Host Cert) shown in FIG. 5 does not have a setting allowing writing (Write) to the divided area #1 (Protected Area #1).

The certificate having such protected area access right information recorded therein, for example, is provided to the user device.

The device intended to access the protected area 51 of the memory card 31 outputs the certificate having this protected area access right information recorded therein to the memory card. The memory card determines whether the access is possible or not on the basis of a certificate verification process in the data processing section within the memory card. The host (recording and reproducing device) 70 accesses the protected area 51 of the memory card 31 according to information on the determination.

The protected area of the memory card is thus configured as an access control area in which the allowance or non-allowance of data writing (Write) and reading (Read) is set in units of access requesting devices and in units of divided areas (#0, #1, #2, . . . ).

As described with reference to FIG. 4, protected area access right information is recorded in the certificate (the server certificate, the host certificate, or the like) of each access requesting device. The memory card first performs a signature verification for the certificate received from an access requesting device, confirms the validity of the signature, and thereafter reads the access control information described in the certificate, that is, the following information:
reading allowing area information (PAD Read); and
writing allowing area information (PAD Write).

On the basis of these pieces of information, only processes allowed to be performed by the access requesting devices are allowed and performed.

Incidentally, the host device includes various types of devices such as CE (Consumer Electronics) devices including for example a recorder and a player as well as PCs.

Device certificates are certificates retained by these respective devices individually, and can have different settings according to the types of these devices.

In addition, the data processing section of the memory card may determine whether to allow access in units of divided areas of the protected area on the basis of not only the following information recorded in the device certificate but also the type information (Type) included in the certificate described with reference to FIG. 4, for example:
reading allowing area information (PAD Read); and
writing allowing area information (PAD Write).

### 5. Example of Process between Host (Reproducing Device) and Medium (Memory Card)

Description will next be made of an example of a process between a host (reproducing device) for reproducing contents stored on the medium (memory card) and the medium (memory card).

### 5-1. First Embodiment

### Example of Process Between Host and Medium Using Device Certificate Corresponding to Content Type

An example of a process using a device certificate corresponding to a content type will first be described as a first embodiment of an example of a process between a host (reproducing device) and the medium (memory card).

Contents provided from the broadcasting station and the content sever to the user device include various types of contents. For example, there are various types of contents as follows:
movie contents;
music contents;
moving image contents; and
still image contents.

Further, movie contents, for example, include movie contents that have been released only recently, movie contents that were released a certain time ago, and the like.

If illegal copies of new contents such as a new movie released only recently or the like are distributed, the content value of the new contents is decreased sharply, and the benefits of the copyright holder and the distribution right holder are significantly impaired.

On the other hand, as for old contents such as an old movie that was released a few years ago and whose sales in the form of DVDs and the like have passed a peak, the benefit levels of the copyright holder and the distribution right holder have already been decreased, and thus the production of illegal copies thereof has a relatively small effect.

Thus, contents differ in value according to the types of the contents, and there are high-value-added contents to be protected from illegal use more securely and other contents.

In the following description,
contents to be protected from illegal use securely will be referred to as high-value-added contents (Enhanced Content), and
contents other than the high-value-added contents will be referred to as ordinary contents (Basic Content).

An example of a process using a device certificate corresponding to a content type will be described as an example of a measure to deal with such a present situation in which there are various types of contents and strengthen the protection of the high-value-added contents (Enhanced Content).

The device certificate is for example the host certificate (Host Cert) described earlier with reference to FIG. 4.

As described with reference to FIG. 4 and FIG. 5, various access right information indicating access rights, or specifically the allowance of only reading (Read), the allowance of only writing (Write), the allowance of reading and writing (Read/Write), and the like, in units of divided areas (#0, #1, #2, . . . ) of the protected area of the memory card is recorded in the device certificate.

A plurality of such device certificates are issued according to types of contents, and one content certificate is set as a content certificate usable only for a specific type of contents.

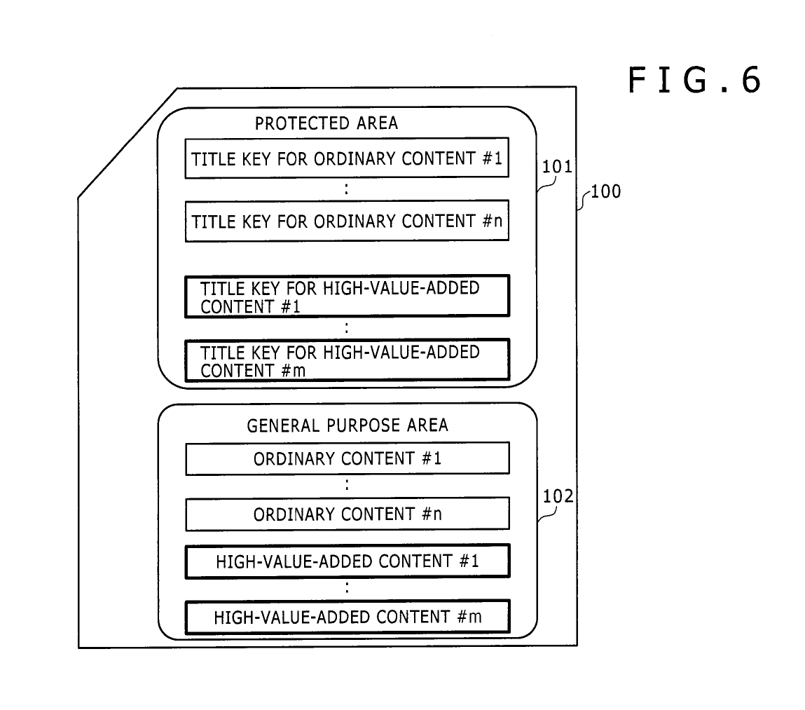

FIG. 6 shows an example of storage of encrypted contents recorded on a memory card 100 and title keys applied to the decryption of the encrypted contents.

As described above, the memory card 100 is divided into the following two areas:
a protected area 101; and
a general purpose area 102.

Encrypted contents are recorded in the general purpose area 102.

As shown in FIG. 6, contents are divided into the following two types of contents:
(a) ordinary contents (Basic Content); and
(b) high-value-added contents (Enhanced Content).

Each content is recorded with a setting that enables determination of a content type, for example ordinary contents (Basic Content) or high-value-added contents (Enhanced Content). Each content is recorded together with metadata having these content types recorded therein, for example.

These contents are encrypted contents. At a time of reproduction of the contents, a decryption process using a title key corresponding to each content (title) needs to be performed.

The title key is recorded in the protected area 101. Incidentally, the title key may be recorded as encrypted or converted data. This is one of measures against leakage.

As shown in FIG. 6, as with types of encrypted contents, title keys recorded in the protected area 101 are roughly classified into the following two types:
(a) a title key corresponding to ordinary contents (Title Key for Basic Content); and
(b) a title key corresponding to high-value-added contents (Title Key for Enhanced Content).

Each title key is recorded as a setting that enables determination of a type of contents to be decrypted with the title key, for example ordinary contents (Basic Content) or high-value-added contents (Enhanced Content). Each title key is recorded together with metadata having these content types recorded therein, for example.

Incidentally, the two types of title keys may be stored in different divided areas for the respective types, and corresponding content types may be allowed to be determined on the basis of the divisions in which the title keys are recorded. In this case, access control can be performed under different access rights in units of the divisions.

A reproducing device (host) for reproducing contents, for example a reproducing device such as a recording and reproduction only device, a PC, a portable terminal, or the like, needs to read a title key corresponding to contents to be reproduced from the protected area of the memory card when reproducing the contents.

For this title key reading process, the reproducing device (host) presents a device certificate (Cert) to the memory card.

In this case, as described above, the device certificate is set as a device certificate corresponding to a content type.

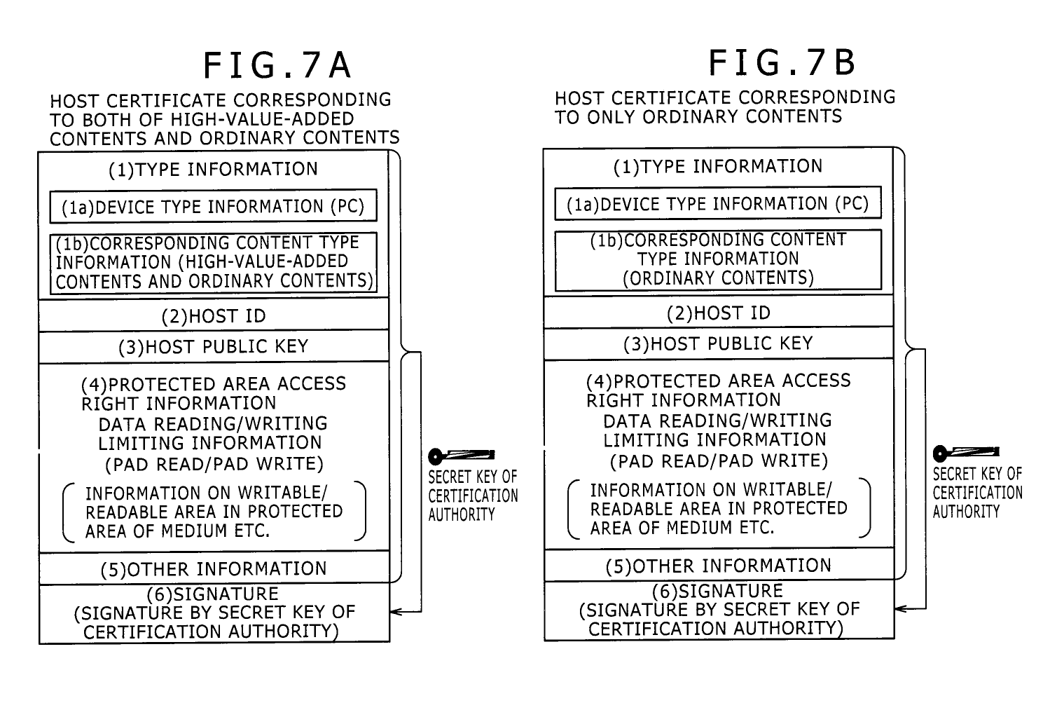

An example of configuration of host certificates (Host Cert) corresponding to content types is shown in FIGS. 7A and 7B.

FIGS. 7A and 7B show an example of the following two types of host certificates (Host Cert):
(A) a host certificate (Host Cert) usable for content reproduction of both of high-value-added contents and ordinary contents; and
(B) a host certificate (Host Cert) usable for content reproduction of only ordinary contents.

The host certificates (Host Cert) shown in FIGS. 7A and 7B, which are similar to the host certificate described earlier with reference to FIG. 4, are certificates having the following data recorded therein:
(1) type information
(2) host ID (user device ID)
(3) host public key
(4) protected area access right information (reading/writing limiting information (PAD Read/PAD Write) for the protected area of the medium)
(5) other information
(6) signature

However, the host certificates shown in FIGS. 7A and 7B are different in that the following information is recorded as the type information:
(1a) device type information; and
(1b) corresponding content type information.

The “(1a) device type information” indicates the device type of the host retaining the host certificate (Host Cert). Specifically, the device type information for example indicates that the host is a device of one of the following types:
a recording and reproduction only device;
a PC; and
a portable terminal (a tablet type terminal or the like).

The “(1b) corresponding content type information” indicates a type of contents of a title key allowed to be obtained from the memory card using the host certificate (Host Cert). That is, the corresponding content type information indicates that the host certificate (Host Cert) can be used to obtain a title key corresponding to one or both of the following contents:
high-value-added contents (Enhanced Content); and
ordinary contents (Basic Content).

Thus, the device type information indicating the device type of the device itself and the corresponding content type information indicating a type of contents corresponding to a title key obtainable by applying the device certificate are recorded in the device certificate.

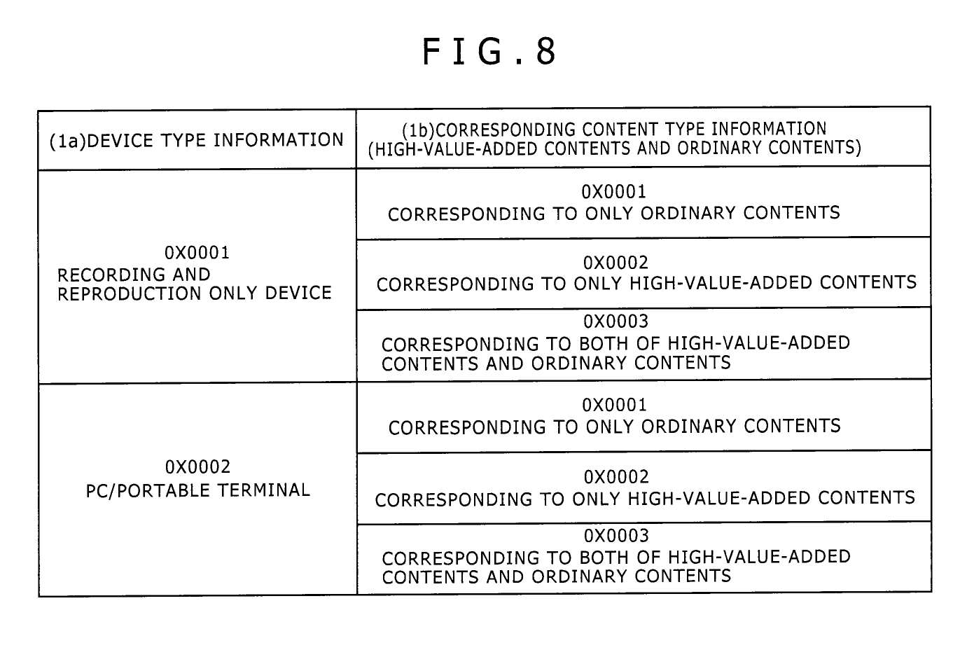

Referring to FIG. 8, description will be made of an example of combinations of the following information:
(1a) device type information; and
(1b) corresponding content type information.

As shown in FIG. 8, the device type information is classified into the following two types:
a recording and reproduction only device (code: 0x0001); and
a PC/portable terminal (tablet type terminal or the like) (code: 0x0002).

Incidentally, this type classification is an example, and the device type information may be subdivided.

The corresponding content type information is classified into the following three types:
corresponding content type information corresponding to only ordinary contents (code: 0x0001);
corresponding content type information corresponding to only high-value-added contents (code: 0x0002); and
corresponding content type information corresponding to both of high-value-added contents and ordinary contents (code: 0x0003).

Incidentally, this type classification is an example, and the corresponding content type information may be subdivided. For example, classifications may be set according to various types of contents such as music contents, movie contents, still image contents, moving image contents, and the like.

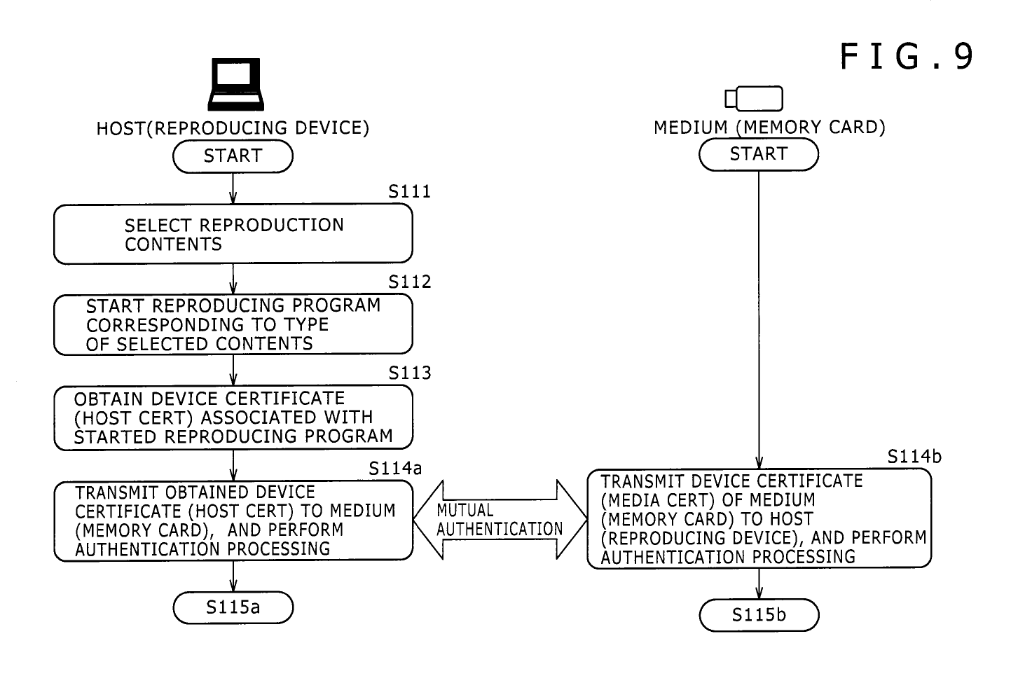

A sequence of a content reproducing process using a device certificate corresponding to a content type will next be described with reference to flowcharts of FIGS. 9 to 11.

The flowcharts of FIGS. 9 to 11 show processes performed by the following two devices in order:
a host (reproducing device) for reproducing contents on a left side; and
a medium (memory card) storing encrypted contents and a title key on a right side.

Details of the processes of respective steps will be described.

The medium (memory card) is loaded into the host (reproducing device). Information on selection of reproduction contents is input to the host (reproducing device) in step S111.

For example, a list of contents stored on the memory card is displayed on the display of the host, and a user selects the reproduction contents from the displayed list of the contents. The data processing section of the host thereby identifies the selected contents specified by the user.

In step S112, the host starts a reproducing program corresponding to the type of the selected contents.

In the present process example, the content type is one of the following:
(a) ordinary contents; and
(b) high-value-added contents.

Incidentally, information indicating the content type of each content is recorded in attribute information (metadata) associated with the content, and the content type is determined on the basis of the attribute information. Alternatively, a content file may be recorded with an extension that differs according to the content type, and the content type may be determined by referring to the extension.

Alternatively, the program to be started may be selected automatically according to the extension.

The host retains an ordinary content reproducing program for reproducing ordinary contents and a high-value-added content reproducing program for reproducing high-value-added contents. The host starts the reproducing program corresponding to the type of the contents selected as an object of reproduction.

Incidentally, some hosts have only an ordinary content reproducing program. Such hosts cannot reproduce high-value-added contents.

In addition, the high-value-added content reproducing program may be set so as to be able to reproduce only high-value-added contents, or may be set so as to be able to reproduce both of high-value-added contents and ordinary contents.

Next, the host in step S113 obtains a device certificate (Host Cert) associated with the reproducing program started according to the content type from the memory of the device itself.

The device certificate (Host Cert) is a host certificate (Host Cert) described earlier with reference to FIG. 7A or 7B, and is a certificate having each of the following pieces of information recorded therein as type information:
(1a) device type information; and
(1b) corresponding content type information.

Incidentally, for example, the ordinary content reproducing program can obtain only a host certificate corresponding to only ordinary contents which host certificate is shown in FIG. 7B.

The high-value-added content reproducing program can obtain only a host certificate corresponding to high-value-added contents and ordinary contents which host certificate is shown in FIG. 7A.

For example, only information (address) corresponding to one of the host certificates of FIGS. 7A and 7B is recorded as information (for example a memory address) for obtaining the host certificate which information is recorded in each reproducing program. Each reproducing program can obtain the sole host certificate usable by the reproducing program itself.

Next, a mutual authentication process between the host (reproducing device) and the medium (memory card) is performed in step S114a and step S114b.

In the mutual authentication process, the host (reproducing device) transmits the host certificate (Host Cert) obtained from the memory of the host to the medium (memory card).

Meanwhile, the medium (memory card) transmits a device certificate (Media Cert) corresponding to the medium which device certificate is stored in a memory within the medium (memory card) to the host (reproducing device).

The authentication process is for example performed as the mutual authentication process of a public key cryptosystem to which the two public key certificates are applied.

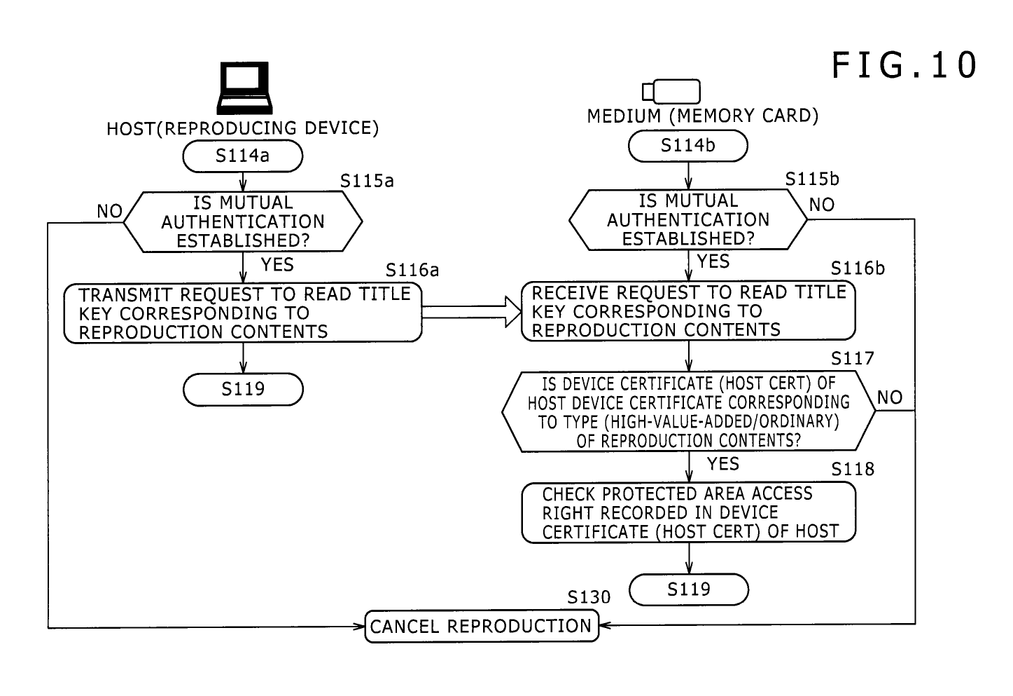

The processes of steps S115a, S115b and subsequent steps shown in FIG. 10 will next be described.

In steps S115a and S115b, whether mutual authentication between the host (reproducing device) and the medium (memory card) is established is determined.

When the mutual authentication is not established, it is determined that the reliability of the two devices cannot be confirmed. The process then proceeds to step S130 to stop the content reproducing process.

When the mutual authentication is established, the process proceeds to steps S116a and S116b.

The host (reproducing device) in step S116a transmits a request to read a title key corresponding to the reproduction contents to the medium (memory card).

The medium (memory card) in step S116b receives the request to read the title key.

Next, in step S117, referring to the type information of the host certificate (Host Cert) received from the host (reproducing device) in the previous authentication process, the medium (memory card) determines whether the host certificate (Host Cert) received from the host (reproducing device) is a host certificate (Host Cert) in which corresponding content type information corresponding to the type of the contents corresponding to the title key requested by the host is recorded.

For example, suppose that the two kinds of host certificates (Host Cert) shown in FIGS. 7A and 7B can be used.

When the contents intended to be reproduced are ordinary contents, and the title key requested by the host is a title key corresponding to the ordinary contents, a determination in step S117 is Yes when the host certificate received from the host is either of the following two kinds of host certificates (Host Cert) shown in FIGS. 7A and 7B:
(A) a host certificate (Host Cert) usable for content reproduction of both of high-value-added contents and ordinary contents; and
(B) a host certificate (Host Cert) usable for content reproduction of only ordinary contents.

When the contents intended to be reproduced are high-value-added contents, and the title key requested by the host is a title key corresponding to the high-value-added contents, the determination in step S117 is Yes only when the host certificate received from the host is the following kind of host certificate (Host Cert) shown in FIG. 7A:
(A) a host certificate (Host Cert) usable for content reproduction of both of high-value-added contents and ordinary contents.

The determination in step S117 is No when the host certificate received from the host is the following kind of host certificate (Host Cert) shown in FIG. 7B:
(B) a host certificate (Host Cert) usable for content reproduction of only ordinary contents.

When the determination in step S117 is No, the process proceeds to step S130 to stop the content reproducing process. That is, the title key is not provided to the host.

When it is determined that the host certificate (Host Cert) received from the host (reproducing device) is a host certificate (Host Cert) in which corresponding content type information corresponding to the type of the contents corresponding to the title key requested by the host is recorded, the determination in step S117 is Yes, and the process proceeds to step S118.

Next, in step S118, referring to the protected area access right information of the host certificate (Host Cert) received from the host (reproducing device) in the previous authentication process, the medium (memory card) checks whether an area storing the title key requested by the host, that is, a divided area of the protected area is set as a data reading allowing area.

As described earlier with reference to FIG. 4 and FIG. 5, access right (reading/writing) allowance information in units of the divided areas of the protected area of the memory card is recorded in the area of the protected area access right information in the host certificate (Host Cert).

Referring to the protected area access right information, the medium (memory card) determines whether an area storing the title key requested by the host, that is, a divided area of the protected area is set as a data reading allowing area.

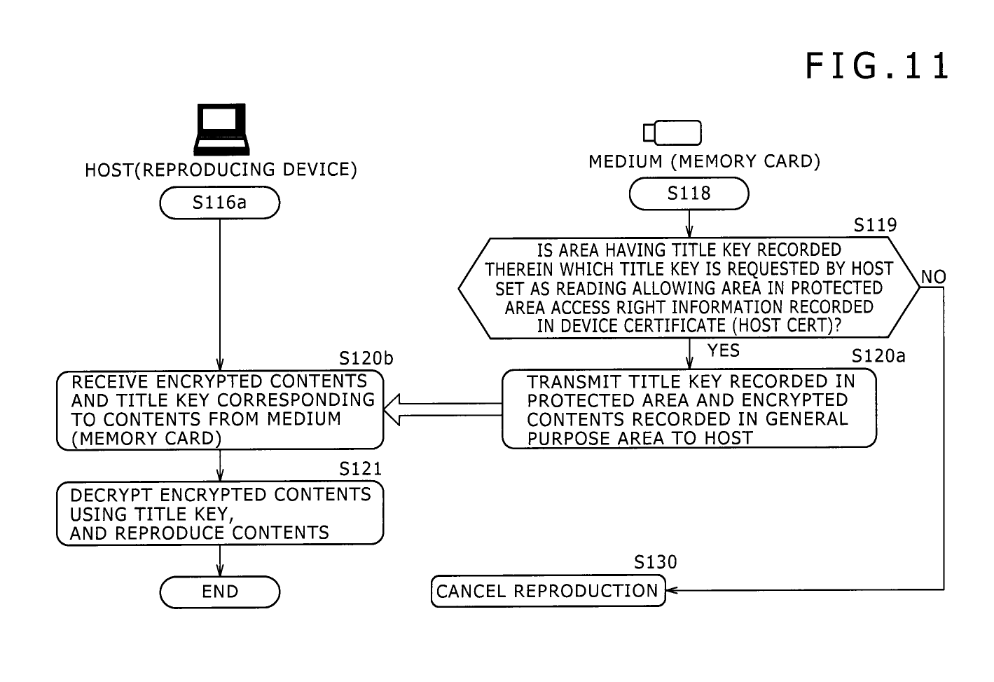

In step S119 shown in FIG. 11, when the divided area of the protected area which divided area stores the title key requested by the host is not recorded as a data reading allowing area in the host certificate (Host Cert), a determination in step S119 is No.

In this case, the process proceeds to step S130 to stop the content reproducing process. That is, the title key is not provided to the host.

On the other hand, when the divided area of the protected area which divided area stores the title key requested by the host is recorded as a data reading allowing area in the host certificate (Host Cert), the determination in step S119 is Yes, and the process proceeds to steps S120a and S120b.

The medium (memory card) in step S120a obtains the title key requested by the host (reproducing device) from the protected area and also obtains encrypted contents from the general purpose area, and transmits the title key and the encrypted contents to the host.

The host (reproducing device) in step S120b receives the title key and the encrypted contents from the medium (memory card).

Next, the host (reproducing device) in step S121 decrypts the encrypted contents by applying the obtained title key, and starts reproducing the contents.

### 5-2. Second Embodiment

### Example of Process in which Reproducing Program Selects Device Certificate to be Applied

In the content reproducing sequence according to the first embodiment which sequence has been described with reference to the flowcharts of FIGS. 9 to 11, a reproducing program to be started is selected according to a type of contents selected as reproduction contents, and a process is performed using a host certificate (Host Cert) set so as to correspond to the selected and started reproducing program, that is, one host certificate (Host Cert) set accessible by the selected and started reproducing program.

That is, in the first embodiment, the reproducing program is set as a dedicated program corresponding to a content type as follows:
a reproducing program corresponding to ordinary contents; or
a reproducing program corresponding to high-value-added contents.

Each of the reproducing programs is assigned one usable host certificate (Host Cert).

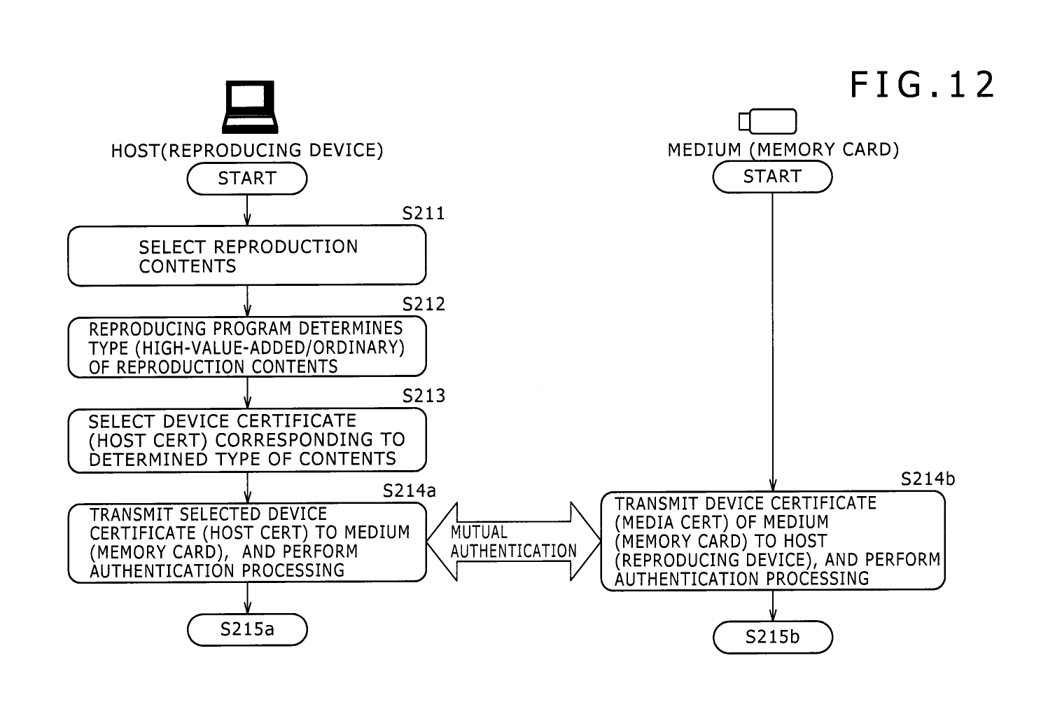

A second embodiment in which a process different from that of the foregoing first embodiment is performed will next be described with reference to flowcharts of FIGS. 12 to 14.

In the second embodiment, a reproducing process is performed by one reproducing program executed in the host (reproducing device), that is, the same program in either of a case where reproduction contents are ordinary contents and a case where reproduction contents are high-value-added contents.

In the present process example, the reproducing program itself determines a type of contents selected as reproduction contents, and selects a host certificate (Host Cert) to be used and uses the host certificate (Host Cert) according to a result of the determination.

That is, as a process of the reproducing program, a content type is determined, and one of the following two types of host certificates (Host Cert) is selected and used according to the determined content type:
(A) a host certificate (Host Cert) usable for content reproduction of both of high-value-added contents and ordinary contents; and
(B) a host certificate (Host Cert) usable for content reproduction of only ordinary contents.

The processes of respective steps in the flowcharts of FIGS. 12 to 14 will be described.

As with the flowcharts of FIGS. 9 to 11, the flowcharts of FIGS. 12 to 14 show processes performed by the following two devices in order:
a host (reproducing device) for reproducing contents on a left side; and
a medium (memory card) storing encrypted contents and a title key on a right side.

The medium (memory card) is loaded into the host (reproducing device). Information on selection of reproduction contents is input to the host (reproducing device) in step S211.

For example, a list of contents stored on the memory card is displayed on the display of the host, and a user selects the reproduction contents from the displayed list of the contents. The data processing section of the host thereby identifies the selected contents. For example, the content reproducing program stored in the memory of the host is started with the selection of the reproduction contents as a trigger.

Incidentally, while the started program in the process of the flow shown in previous FIGS. 9 to 11 differs according to a content type (high-value-added/ordinary), the started program in the present process example is not changed according to the type (high-value-added/ordinary) of the selected contents.

In step S212, the reproducing program determines the type of the contents selected by the user. Also in the present process example, the content type is one of the following:
(a) ordinary contents; and
(b) high-value-added contents.

Incidentally, information indicating the content type of each content is recorded in attribute information (metadata) associated with the content, and the content type is determined on the basis of the attribute information. Alternatively, a content file may be recorded with an extension that differs according to the content type, and the content type may be determined by referring to the extension.

Next, the host in step S213 selects and obtains a host certificate (Host Cert) to be used from the memory of the device itself according to the determined content type.

The device certificate (Host Cert) is a host certificate (Host Cert) described earlier with reference to FIG. 7A or 7B, and is a certificate having each of the following pieces of information recorded therein as type information:
(1a) device type information; and
(1b) corresponding content type information.

In the present process example, the reproducing program itself selects the host certificate (Host Cert) corresponding to the type of the contents intended to be reproduced.

When the contents selected as reproduction contents are high-value-added contents, the reproducing program selects and obtains a host certificate (Host Cert) in which high-value-added contents are set as usable contents in the corresponding content type information of the host certificate (Host Cert) described with reference to FIG. 7A, for example.

That is, the host certificate shown in FIG. 7A, for example, is selected and obtained.

On the other hand, when the contents selected as reproduction contents are ordinary contents, the reproducing program selects and obtains a host certificate (Host Cert) in which ordinary contents are set as usable contents in the corresponding content type information of the host certificate (Host Cert) described with reference to FIG. 7B, for example.

That is, the host certificate shown in FIG. 7B, for example, is selected and obtained. Incidentally, in this case, the certificate shown in FIG. 7A may also be selected because the certificate shown in FIG. 7A can also be used for the reproduction of ordinary contents.

However, when high-value-added contents are selected as reproduction contents in a case where the host (reproducing device) retains only the host certificate (Host Cert) corresponding to ordinary contents shown in FIG. 7B, for example, the usable host certificate (Host Cert) cannot be obtained, and therefore the contents are not reproduced.

The host (reproducing device) in step S213 thus selects and obtains one of the following two types of host certificates (Host Cert) shown in FIGS. 7A and 7B, for example, according to the content type:
(A) a host certificate (Host Cert) usable for content reproduction of both of high-value-added contents and ordinary contents; and
(B) a host certificate (Host Cert) usable for content reproduction of only ordinary contents.

Next, in step S214a and step S214b, a mutual authentication process between the host (reproducing device) and the medium (memory card) is performed.

In the mutual authentication process, the host (reproducing device) transmits the host certificate (Host Cert) selected according to the content type from the memory of the host to the medium (memory card).

Meanwhile, the medium (memory card) transmits a device certificate (Media Cert) corresponding to the medium which device certificate is stored in a memory within the medium (memory card) to the host (reproducing device).

The authentication process is for example performed as the mutual authentication process of a public key cryptosystem to which the two public key certificates are applied.

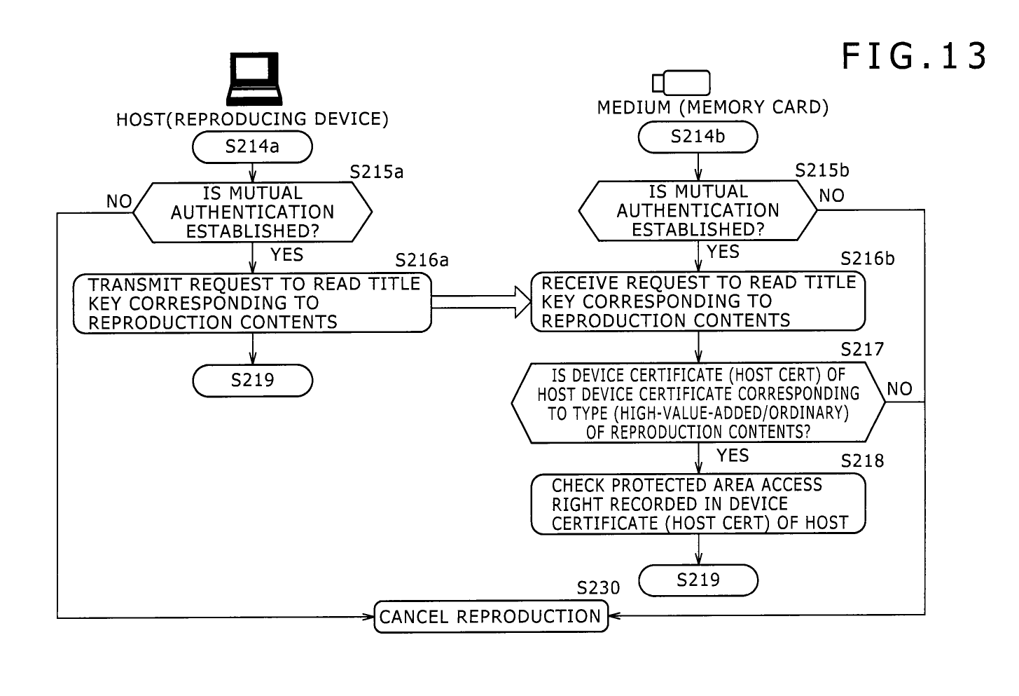

The processes of steps S215a and S215b and subsequent steps shown in FIG. 13 will next be described.

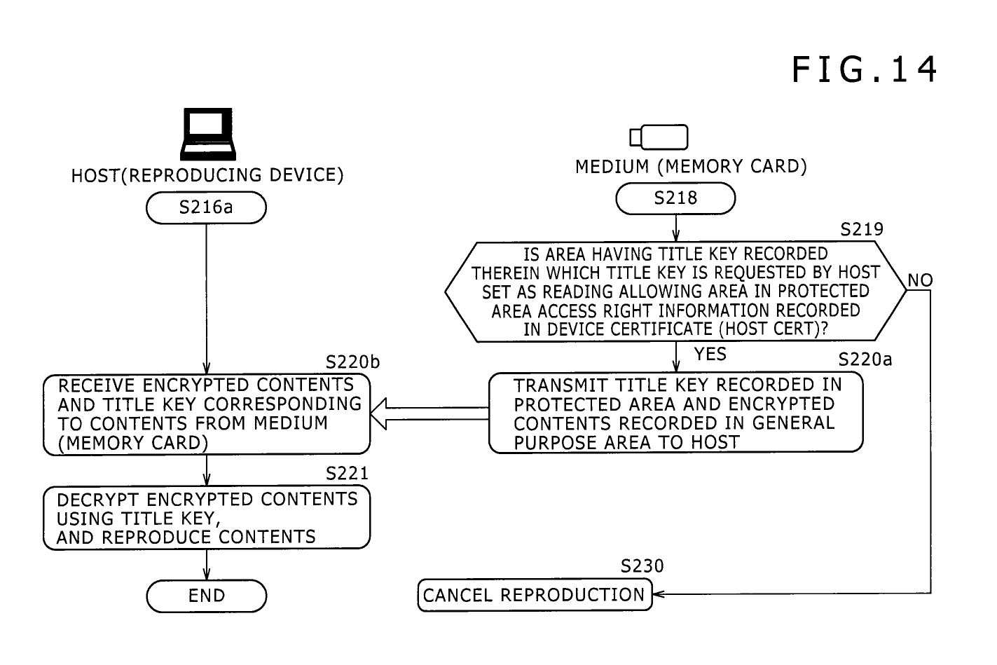

The processes of steps S215a and S215b to S221 shown in FIG. 13 and FIG. 14 are basically similar to the processes of steps S115a and S115b to S121 in the flow described earlier with reference to FIGS. 9 to 11.

In steps S215a and S215b, whether mutual authentication between the host (reproducing device) and the medium (memory card) is established is determined.

When the mutual authentication is not established, it is determined that the reliability of the two devices cannot be confirmed. The process then proceeds to step S230 to stop the content reproducing process.

When the mutual authentication is established, the process proceeds to steps S216a and S216b.

The host (reproducing device) in step S216a transmits a request to read a title key corresponding to the reproduction contents to the medium (memory card).

The medium (memory card) in step S216b receives the request to read the title key.

Next, in step S217, referring to the type information of the host certificate (Host Cert) received from the host (reproducing device) in the previous authentication process, the medium (memory card) determines whether the host certificate (Host Cert) received from the host (reproducing device) is a host certificate (Host Cert) in which corresponding content type information corresponding to the type of the contents corresponding to the title key requested by the host is recorded.

For example, suppose that the two kinds of host certificates (Host Cert) shown in FIGS. 7A and 7B can be used.

When the contents intended to be reproduced are ordinary contents, and the title key requested by the host is a title key corresponding to the ordinary contents, a determination in step S217 is Yes when the host certificate received from the host is either of the following two kinds of host certificates (Host Cert) shown in FIGS. 7A and 7B:
(A) a host certificate (Host Cert) usable for content reproduction of both of high-value-added contents and ordinary contents; and
(B) a host certificate (Host Cert) usable for content reproduction of only ordinary contents.

When the contents intended to be reproduced are high-value-added contents, and the title key requested by the host is a title key corresponding to the high-value-added contents, the determination in step S217 is Yes only when the host certificate received from the host is the following kind of host certificate (Host Cert) shown in FIG. 7A:
(A) a host certificate (Host Cert) usable for content reproduction of both of high-value-added contents and ordinary contents.

The determination in step S217 is No when the host certificate received from the host is the following kind of host certificate (Host Cert) shown in FIG. 7B:
(B) a host certificate (Host Cert) usable for content reproduction of only ordinary contents.

When the determination in step S217 is No, the process proceeds to step S230 to stop the content reproducing process. That is, the title key is not provided to the host.

When it is determined that the host certificate (Host Cert) received from the host (reproducing device) is a host certificate (Host Cert) in which corresponding content type information corresponding to the type of the contents corresponding to the title key requested by the host is recorded, the determination in step S217 is Yes, and the process proceeds to step S218.

Next, in step S218, referring to the protected area access right information of the host certificate (Host Cert) received from the host (reproducing device) in the previous authentication process, the medium (memory card) checks whether an area storing the title key requested by the host, that is, a divided area of the protected area is set as a data reading allowing area.

As described earlier with reference to FIG. 4 and FIG. 5, access right (reading/writing) allowance information in units of the divided areas of the protected area of the memory card is recorded in the area of the protected area access right information in the host certificate (Host Cert).

Referring to the protected area access right information, the medium (memory card) determines whether an area storing the title key requested by the host, that is, a divided area of the protected area is set as a data reading allowing area.

In step S219 shown in FIG. 14, when the divided area of the protected area which divided area stores the title key requested by the host is not recorded as a data reading allowing area in the host certificate (Host Cert), a determination in step S219 is No.

In this case, the process proceeds to step S230 to stop the content reproducing process. That is, the title key is not provided to the host.

On the other hand, when the divided area of the protected area which divided area stores the title key requested by the host is recorded as a data reading allowing area in the host certificate (Host Cert), the determination in step S219 is Yes, and the process proceeds to steps S220a and S220b.

The medium (memory card) in step S220a obtains the title key requested by the host (reproducing device) from the protected area and also obtains encrypted contents from the general purpose area, and transmits the title key and the encrypted contents to the host.

The host (reproducing device) in step S220b receives the title key and the encrypted contents from the medium (memory card).

Next, the host (reproducing device) in step S221 decrypts the encrypted contents by applying the obtained title key, and starts reproducing the contents.

### 5-3. Third Embodiment

### Example of Process in which Mode of Conversion of Identifier (Media ID) of Medium (Memory Card) is Changed according to Type of Reproducing Device

Description will next be made of an example of a process in which a mode of conversion of the identifier (media ID) of a medium (memory card) is changed according to a type of a reproducing device, as a third embodiment of an example of a process between the host (reproducing device) and the medium (memory card).

The medium (memory card) storing encrypted contents and a title key applied to the decryption of the encrypted contents retains a media ID (MID), which is information for identifying the medium itself.

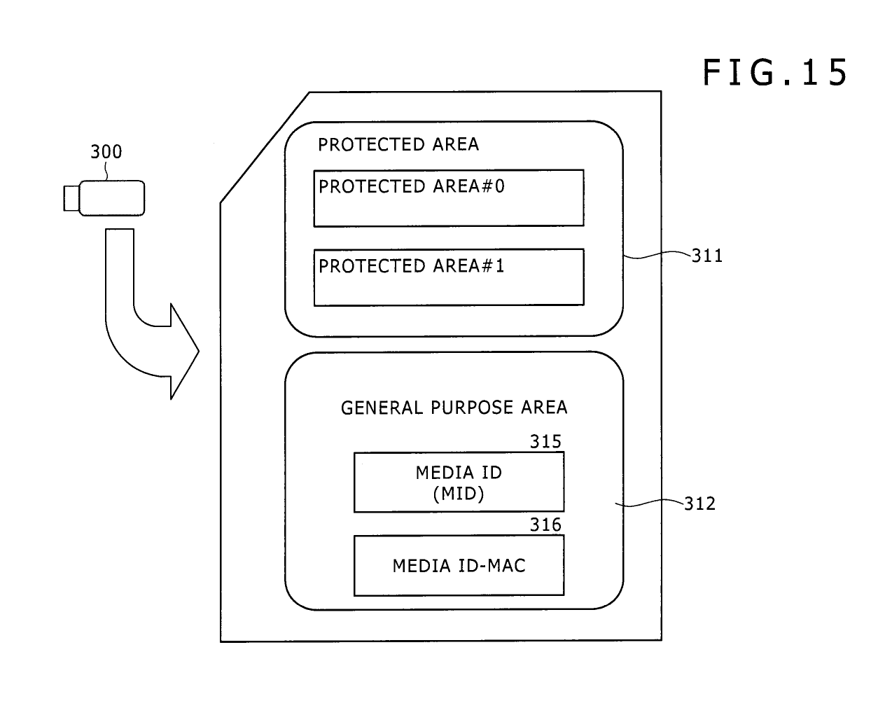

As shown in FIG. 15, the medium (memory card) 300 has a protected area 311 allowing access thereto on the basis of access right information recorded in each device certificate and a general purpose area 312. The medium (memory card) 300 stores a title key in the protected area 311, and stores encrypted contents in the general purpose area 312.

In addition to the encrypted contents, content usage control information (Usage Rule) as well as a media ID (MID) 315 and a media ID-MAC (Message Authentication Code) 316 as a verification value for the media ID, as shown in FIG. 15, are recorded in the general purpose area 312.

The media ID (MID) 315 is an identifier of the medium (memory card), and is set as a value different for each medium (value unique to the medium).

The media ID-MAC 316 is a tampering verification value for the media ID (MID) 315, and is configured as data to which the electronic signature of an administrator is set, for example.

When the contents recorded on the medium (memory card) 300 are reproduced, the media ID (MID) 315 and the media ID-MAC 316 are read by the reproducing device (host), and a verification process using MAC is performed. A transition can be made to the decryption of the encrypted contents using the title key on condition that the validity of the media ID (MID) 315 is confirmed by the verification process.

A content reproducing program stored in the reproducing device (host) in advance performs the verification of the media ID (MAC) and the decryption of the encrypted contents to which decryption the title key is applied according to a reproducing process sequence thus determined in advance.

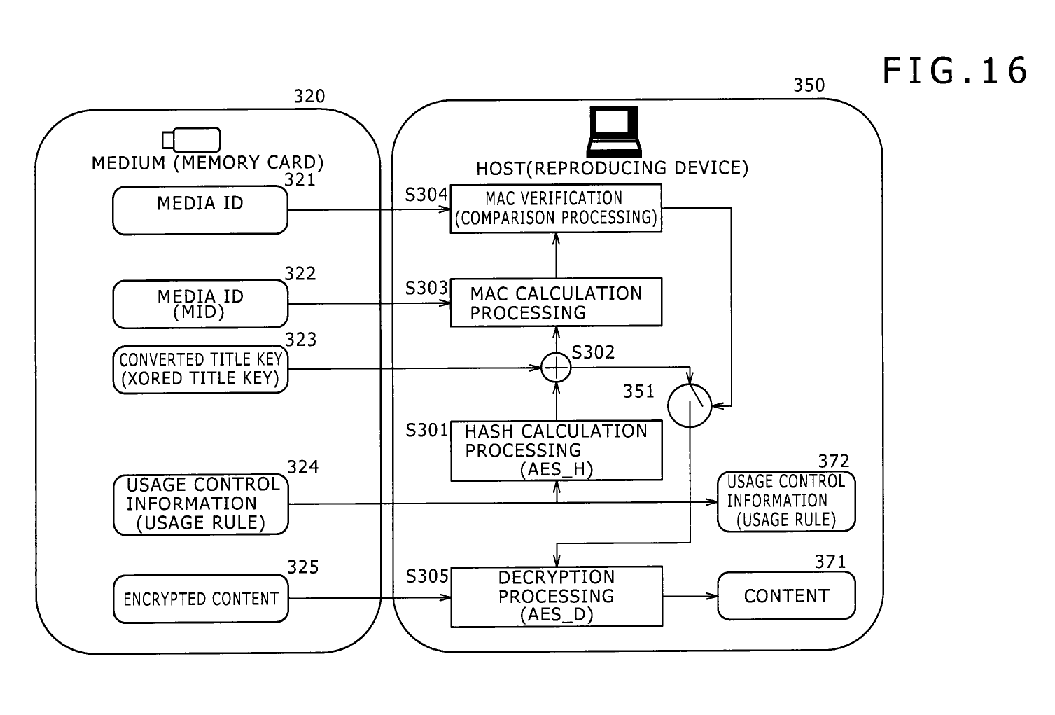

Referring to FIG. 16, description will be made of an example of a sequence of the verification of the media ID (MAC) and the decryption of the encrypted contents to which decryption the title key is applied.

FIG. 16 shows a medium (memory card) 320 storing encrypted contents and the like and a host (reproducing device) 350 for decrypting and reproducing the encrypted contents stored on the medium (memory card) 320.

The medium (memory card) 320 stores the following data as shown in FIG. 16:
a media ID-MAC 321;
a media ID (MID) 322;
a converted title key (XORed Title Key) 323;
usage control information (Usage Rule) 324; and
encrypted contents 325.

Incidentally, the medium (memory card) 320 stores various other data. However, only the data applied in the sequence of the verification of the media ID (MAC) and the decryption of the encrypted contents to which decryption the title key is applied is shown.

The usage control information (Usage Rule) 324 corresponds to the encrypted contents 325. Specifically, for example, the usage control information (Usage Rule) 324 is data in which usage allowance information such as content copy allowance information or the like is recorded. At a time of use of the encrypted contents 325, the host (reproducing device) uses the contents according to the specifications of the usage control information (Usage Rule) 324.

The converted title key (XORed Title Key) 323 is converted data of the title key, and is stored in the protected area of the memory card.

Specifically, a result of an exclusive disjunction (XOR) of title key data and the hash value of the usage control information (Usage Rule) 324 is stored as the converted title key.

A process sequence of the host (reproducing device) 350 will be described.

A process performed by the host (reproducing device) 350 will be described in order of steps S301 to S305 shown in FIG. 16.

First, the host (reproducing device) 350 in step S301 reads the usage control information (Usage Rule) 324 from the medium (memory card) 320, and calculates the hash value of the usage control information (Usage Rule) 324. The host (reproducing device) 350 for example calculates the hash value according to an AES encryption algorithm.

Next, the host (reproducing device) 350 in step S302 calculates an exclusive disjunction (XOR) of the converted title key (XORed Title Key) 323 read from the protected area of the medium (memory card) 320 according to a predetermined procedure including access right confirmation and the like and the hash value of the usage control information (Usage Rule) 324. A title key is generated by this process.

Next, the host (reproducing device) 350 in step S303 performs MAC calculation by applying the title key generated in step S302 to the media ID (MID) 322 read from the medium (memory card) 320.

Next, the host (reproducing device) 350 in step S304 verifies the media ID-MAC 321 read from the medium (memory card) 320 against the MAC value calculated in step S303.

When the media ID-MAC 321 read from the medium (memory card) 320 matches the calculated MAC value calculated in step S303 in the verifying process, MAC verification is established, and it is determined that the validity of the medium (memory card) 320 is confirmed. The process then proceeds to the process of decryption of the encrypted contents to which decryption the title key is applied.

On the other hand, when the media ID-MAC 321 read from the medium (memory card) 320 does not match the calculated MAC value calculated in step S303 in the verifying process, MAC verification is not established, and it is not determined that the validity of the medium (memory card) 320 is confirmed. Therefore the process of decryption of the encrypted contents to which decryption the title key is applied is not performed.

Incidentally, FIG. 16 shows a switch 351 to describe the performance or non-performance of the process based on the determination process. This switch 351 is shown to describe the process algorithm, and is not necessary as actual hardware configuration.

When the media ID-MAC 321 read from the medium (memory card) 320 matches the calculated MAC value calculated in step S303 in the MAC verification process in step S304, and thus the validity of the medium is confirmed, the process proceeds to step S305.

The host (reproducing device) 350 in step S305 generates contents 371 by subjecting the encrypted contents 325 read from the medium (memory card) 320 to a decrypting process to which the title key generated from the converted title key 323 in step S302 is applied, and performs a content use process such as content reproduction or the like.

Incidentally, this content use is desired to be made in a use mode complying with the specifications of the usage control information (Usage Rule) 324 read from the medium (memory card) 320.

Thus, at a time of the process of decrypting and reproducing the contents stored on the medium (memory card), the validity of the medium needs to be confirmed using the media ID (MID), which is the identifier of the medium.

There are various types of content devices for reproducing contents. For example, as described earlier with reference to FIG. 1 and FIG. 2, there are various devices including:
a recording and reproduction only device (CE device) 21 such as a DVD player, a BD player, or the like);
a PC 22; and
a portable terminal 23 such as a smart phone, a tablet terminal, or the like.

An embodiment to be described in the following is an example of configuration in which a mode of conversion of the identifier (media ID) of the medium (memory card) is changed according to the types of these various reproducing devices.

Specifically, when the medium (memory card) outputs the media ID (MID) to a host (reproducing device) for reproducing contents, the medium (memory card) performs a data converting process (Encode) different according to the type of the host (reproducing device), and provides the converted media ID (MID) to the host (reproducing device).

The host (reproducing device) subjects the converted media ID (MID) received from the medium (memory card) to a restoring process (Decode) according to the type of the device, and obtains the media ID (MID).

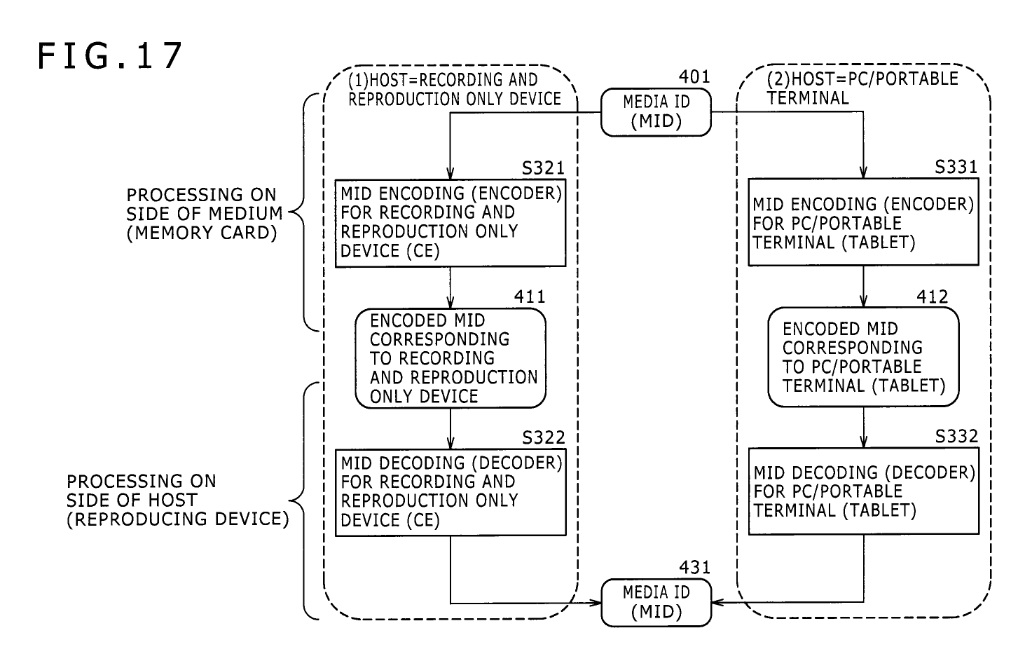

A concrete example will be described with reference to FIG. 17.

FIG. 17 represents an example in which the device (host) for reproducing contents is classified into two types.
(1) Host=Recording and Reproduction Only Device
(2) Host=PC and Portable Terminal
   FIG. 17 shows an example in which the device (host) for reproducing contents is classified into these two types, and a process different according to each type is performed.

The medium (memory card) has a media ID (MID) 401 stored in a memory.

The medium (memory card) checks that the type of a host (reproducing device) that is loaded with the medium (memory card) and which reproduces contents within the medium is one of the following types:
(1) Host=Recording and Reproduction Only Device
(2) Host=PC or Portable Terminal

Incidentally, the process of checking the type of the host (type of the reproducing device) can be performed by checking the type information (see FIGS. 7A and 7B and FIG. 8) of a host certificate (Host Cert) that the medium (memory card) receives from the host (reproducing device) in a mutual authentication process performed between the host (reproducing device) and the medium (memory card), for example.

When the medium (memory card) determines that the host (reproducing device) is a recording and reproduction only device, a process (1) Host=Recording and Reproduction Only Device shown on a left side of FIG. 17 is performed.

On the other hand, when the medium (memory card) determines that the host (reproducing device) is a PC or a portable terminal, a process (2) Host=PC/Portable Terminal shown on a right side of FIG. 17 is performed.

In the process for (1) Host=Recording and Reproduction Only Device,
the medium (memory card) in step S321 performs a process of encoding the media ID (MID) which process corresponds to the recording and reproduction only device.

The encoded MID 411 corresponding to the recording and reproduction only device as a result of the encoding is provided to the recording and reproduction only device as a host (reproducing device).

The recording and reproduction only device as a host (reproducing device) in step S322 decodes the encoded MID 411 corresponding to the recording and reproduction only device which encoded MID is received from the medium (memory card) by applying a decoding algorithm corresponding to the recording and reproduction only device which decoding algorithm is possessed by the device itself. The recording and reproduction only device thereby obtains the media ID (MID) 431.

On the other hand, in the case of (2) Host=PC or Portable Terminal,

the medium (memory card) in step S331 performs a process of encoding the media ID (MID) which process corresponds to a PC and a portable terminal.

The encoded MID 412 corresponding to the PC/portable terminal as a result of the encoding is supplied to a PC or a portable terminal as a host (reproducing device).

The PC or the portable terminal as a host (reproducing device) in step S332 decodes the encoded MID 412 corresponding to the PC/portable terminal received from the medium (memory card) by applying a decoding algorithm corresponding to the PC or the portable terminal which decoding algorithm is possessed by the device itself. The PC or the portable terminal thereby obtains the media ID (MID) 431.

The medium (memory card) is configured to be able to perform a plurality of different encoding algorithms for encoding the media ID (MID), and for example selects and applies an encoding algorithm according to the type of a host (reproducing device) as follows:
a first encoding algorithm applied to the case of Host=Recording and Reproduction Only Device; and
a second encoding algorithm applied to the case of Host=PC or Portable Terminal.

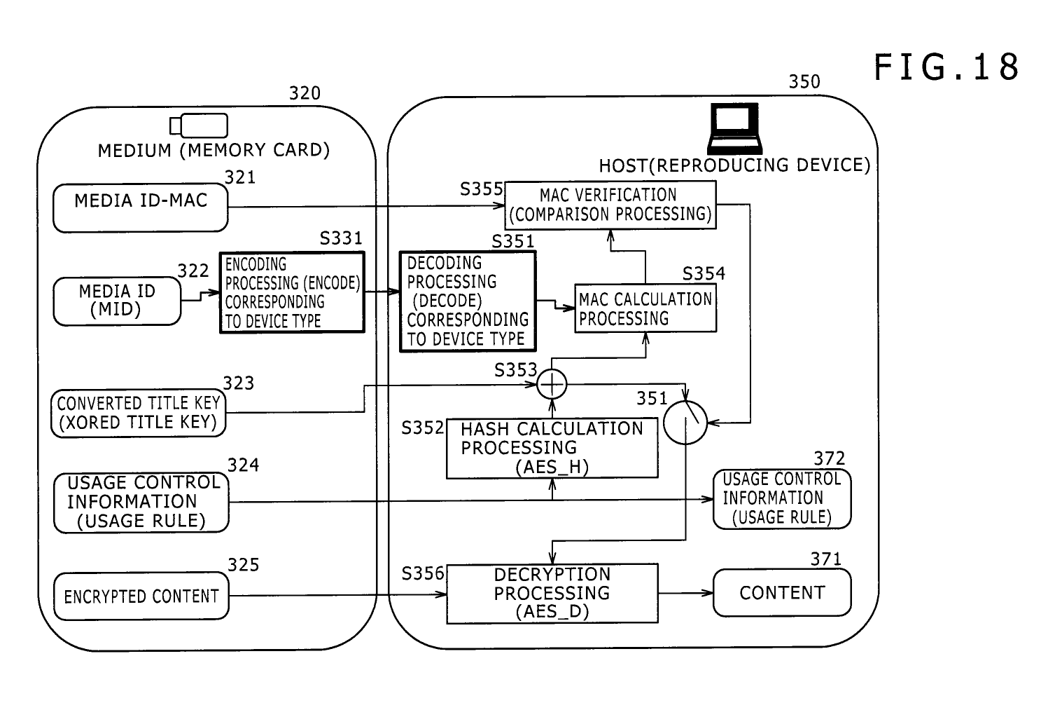

A content decryption and reproducing sequence in a case where a media ID (MID) encoding process is performed according to the type of such a host (reproducing device) will be described with reference to FIG. 18.

As with FIG. 16 described earlier, FIG. 18 is a diagram of assistance in explaining a sequence of the verification of the media ID (MAC) and the decryption of encrypted contents to which decryption a title key is applied.

As with FIG. 16, FIG. 18 shows a medium (memory card) 320 storing encrypted contents and the like and a host (reproducing device) 350 for decrypting and reproducing the encrypted contents stored on the medium (memory card) 320.

The medium (memory card) 320 stores the following data as shown in FIG. 18:
a media ID-MAC 321;
a media ID (MID) 322;
a converted title key (XORed Title Key) 323;
usage control information (Usage Rule) 324; and
encrypted contents 325.

Incidentally, the medium (memory card) 320 stores various other data. However, only the data applied in the sequence of the verification of the media ID (MAC) and the decryption of the encrypted contents to which decryption the title key is applied is shown.

As described earlier with reference to FIG. 16, the converted title key (XORed Title Key) 323 is converted data of the title key, and is stored in the protected area of the memory card.

Specifically, a result of an exclusive disjunction (XOR) of title key data and the hash value of the usage control information (Usage Rule) 324 is stored as the converted title key.

First, the medium (memory card) 320 in step S331 performs a process of encoding the media ID (MID) 322 according to the type of the host (reproducing device) for reproducing the contents.

Incidentally, as a precondition for this process, the medium (memory card) 320 and the host (reproducing device) 350 have performed a mutual authentication process, and the medium (memory card) 320 has received a host certificate (Host Cert) from the host (reproducing device) 350 when the mutual authentication process has been performed.

As described with reference to FIGS. 7A and 7B and FIG. 8, type information is recorded in the host certificate (Host Cert), and device type information indicating the type of the device is recorded in the type information.

The medium (memory card) 320 checks the type of the host (reproducing device) by referring to the type information (device type information) recorded in the host certificate (Host Cert) received from the host (reproducing device) 350.

A mode of encoding of the media ID (MID) (encoding algorithm) is determined according to the checking of the device type, and the media ID (MID) is encoded according to the determined encoding mode (encoding algorithm).

The medium (memory card) 320 provides the encoded media ID (MID) corresponding to the device type which encoded media ID (MID) is generated in step S331 to the host (reproducing device) 350.

The host (reproducing device) 350 in step S351 performs a process of decoding the encoded media ID (MID) received from the medium (memory card) 320.

The host (reproducing device) 350 has a decoding program or a decoder corresponding to the device type. The host (reproducing device) 350 performs a process of decoding the encoded media ID (MID) by applying the decoding program or the decoder corresponding to the device type.

When the host (reproducing device) 350 is a recording and reproduction only device, the recording and reproduction only device retains a decoding program or a decoder associated with the recording and reproduction only device, and performs the process to which the decoding program or the decoder is applied.

When the host (reproducing device) 350 is a PC or a portable terminal such as a tablet terminal or the like, the PC or the portable terminal retains a decoding program or a decoder associated with the PC or the portable terminal, and performs the process to which the decoding program or the decoder is applied.

The host (reproducing device) 350 obtains the media ID (MID) by the decoding process of step S351.

Incidentally, in a case where although the host (reproducing device) 350 is a PC, for example, the PC illegally uses the host certificate (Host Cert) of a recording and reproduction only device, for example, and performs the process while pretending to be the recording and reproduction only device, the PC cannot obtain the media ID (MID), and cannot perform subsequent content reproduction.

This is because in such a case, only the decoding program or the decoder retained by only the recording and reproduction only device can decode the encoded media ID (MID) provided by the medium (memory card), and obtain the media ID.

Processes after the host (reproducing device) 350 obtains the media ID (MID), that is, the processes of steps S352 to S356 are similar to the processes of steps S301 to S305 described earlier with reference to FIG. 16.

The host (reproducing device) 350 in step S352 reads the usage control information (Usage Rule) 324 from the medium (memory card) 320, and calculates the hash value of the usage control information (Usage Rule) 324. The host (reproducing device) 350 for example calculates the hash value according to an AES encryption algorithm.

Next, the host (reproducing device) 350 in step S353 calculates an exclusive disjunction (XOR) of the converted title key (XORed Title Key) 323 read from the protected area of the medium (memory card) 320 according to a predetermined procedure including access right confirmation and the like and the hash value of the usage control information (Usage Rule) 324. A title key is generated by this process.

Next, the host (reproducing device) 350 in step S354 performs MAC calculation by applying the title key generated in step S353 to the media ID (MID) 322 read from the medium (memory card) 320.

Next, the host (reproducing device) 350 in step S355 verifies the media ID-MAC 321 read from the medium (memory card) 320 against the MAC value calculated in step S354.

When the media ID-MAC 321 read from the medium (memory card) 320 matches the calculated MAC value calculated in step S354 in the verifying process, MAC verification is established, and it is determined that the validity of the medium (memory card) 320 is confirmed. The process then proceeds to the process of decryption of the encrypted contents to which decryption the title key is applied in step S356.

On the other hand, when the media ID-MAC 321 read from the medium (memory card) 320 does not match the calculated MAC value calculated in step S354 in the verifying process in step S355, MAC verification is not established, and it is not determined that the validity of the medium (memory card) 320 is confirmed. Therefore the process of decryption of the encrypted contents to which decryption the title key is applied in step S356 is not performed.

Incidentally, this content use is desired to be made in a use mode complying with the specifications of the usage control information (Usage Rule) 324 read from the medium (memory card) 320.

Thus, in the present embodiment, the medium (memory card) determines the type of the host (reproducing device), changes the mode of conversion of the media ID according to the determined type of the host, and provides the converted media ID to the host.

The host obtains the media ID (MID) by applying the decoding algorithm corresponding to the device type which decoding algorithm is provided to the device itself.

With such a configuration, the medium (memory card) can perform process control according to the type of the host (reproducing device).

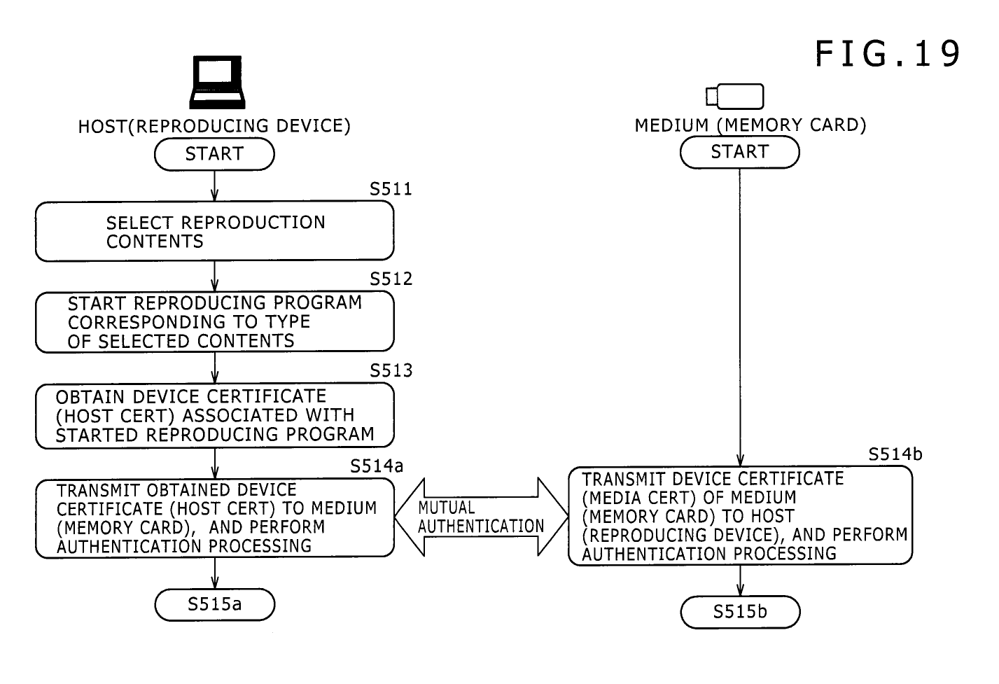

A sequence of a content reproducing process in the present embodiment will next be described with reference to flowcharts of FIGS. 19 to 21.

Specifically, FIGS. 19 to 21 are flowcharts of assistance in explaining the sequence of the content reproducing process involving a process of converting the media ID (MID) according to the type of a host (reproducing device).

The flowcharts of FIGS. 19 to 21 show processes performed by the following two devices in order:
a host (reproducing device) for reproducing contents on a left side; and
a medium (memory card) storing encrypted contents and a title key on a right side.

Details of the processes of respective steps will be described.

The medium (memory card) is loaded into the host (reproducing device). Information on selection of reproduction contents is input to the host (reproducing device) in step S511.

For example, a list of contents stored on the memory card is displayed on the display of the host, and a user selects the reproduction contents from the displayed list of the contents. The data processing section of the host thereby identifies the selected contents.

In step S512, the host starts a reproducing program corresponding to the type of the selected contents.

In the present process example, the content type is one of the following:
(a) ordinary contents; and
(b) high-value-added contents.

That is, the host retains an ordinary content reproducing program for reproducing ordinary contents and a high-value-added content reproducing program for reproducing high-value-added contents. The host starts the reproducing program corresponding to the type of the contents selected as an object of reproduction.

Incidentally, some hosts have only an ordinary content reproducing program. Such hosts cannot reproduce high-value-added contents.

In addition, the high-value-added content reproducing program may be set so as to be able to reproduce only high-value-added contents, or may be set so as to be able to reproduce both of high-value-added contents and ordinary contents.

Next, the host in step S513 obtains a device certificate (Host Cert) associated with the reproducing program started according to the content type from the memory of the device itself.

The device certificate (Host Cert) is a host certificate (Host Cert) described earlier with reference to FIG. 7A or 7B, and is a certificate having each of the following pieces of information recorded therein as type information:
(1a) device type information; and
(1b) corresponding content type information.

Incidentally, for example, the ordinary content reproducing program can obtain only a host certificate corresponding to only ordinary contents which host certificate is shown in FIG. 7B.

The high-value-added content reproducing program can obtain only a host certificate corresponding to high-value-added contents and ordinary contents which host certificate is shown in FIG. 7A.

For example, only information (address) corresponding to one of the host certificates of FIGS. 7A and 7B is recorded as information (for example a memory address) for obtaining the host certificate which information is recorded in each reproducing program. Each reproducing program can obtain the sole host certificate usable by the reproducing program itself.

Next, a mutual authentication process between the host (reproducing device) and the medium (memory card) is performed in step S514a and step S514b.

In the mutual authentication process, the host (reproducing device) transmits the host certificate (Host Cert) obtained from the memory of the host to the medium (memory card).

Meanwhile, the medium (memory card) transmits a device certificate (Media Cert) corresponding to the medium which device certificate is stored in a memory within the medium (memory card) to the host (reproducing device).

The authentication process is for example performed as the mutual authentication process of a public key cryptosystem to which the two public key certificates are applied.

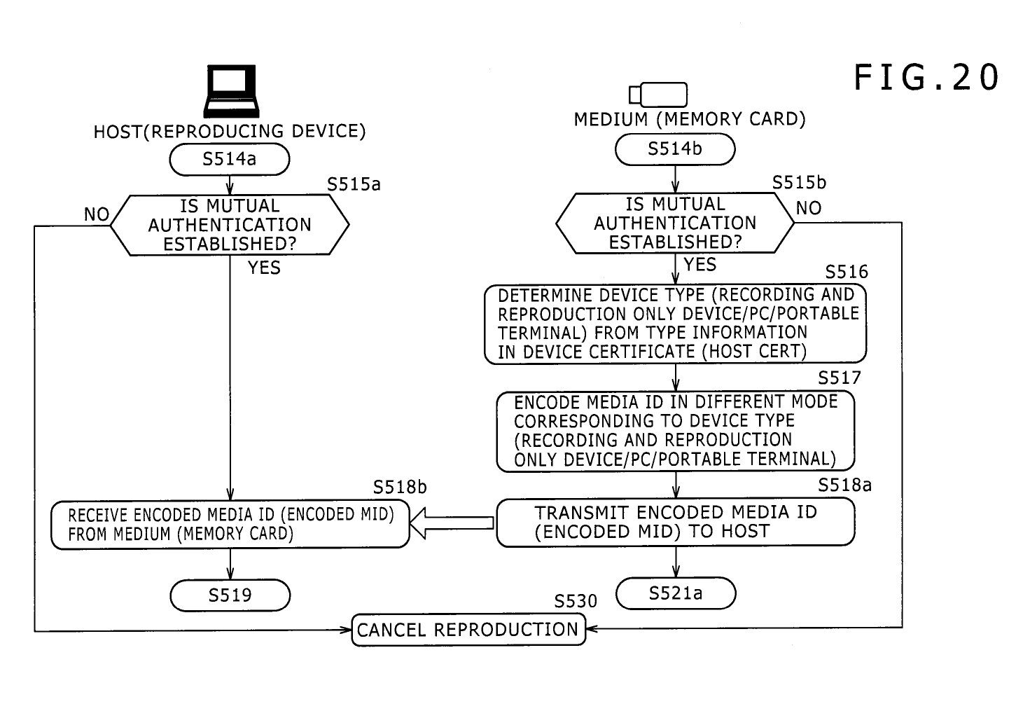

The processes of steps S515a and S515b and subsequent steps shown in FIG. 20 will next be described.

In steps S515a and S515b, whether mutual authentication between the host (reproducing device) and the medium (memory card) is established is determined.

When the mutual authentication is not established, it is determined that the reliability of the two devices cannot be confirmed. The process then proceeds to step S530 to stop the content reproducing process.

When the mutual authentication is established, the medium (memory card) in step S516 determines the type of the host (reproducing device) on the basis of the device type information included in the type information of the host certificate (Host Cert). The medium (memory card) for example determines the device type by for example determining whether the host is a recording and reproduction only device, a PC, or a portable terminal such as a tablet terminal or the like.

Next, the medium (memory card) in step S517 encodes the media ID (MID) according to the type (for example a recording and reproduction only device, a PC, or a portable terminal) of the host (reproducing device), which type is determined on the basis of the type information of the host certificate (Host Cert), and according to an encoding algorithm set in association with the device type in advance.

The medium (memory card) is configured to be able to select and perform a plurality of encoding algorithms. The medium (memory card) selects one of the plurality of encoding algorithms according to the type of the host (reproducing device), and then encodes the media ID (MID).

Next, in step S518a, the medium (memory card) transmits the encoded media ID (MID) to the host (reproducing device).

In step S518b, the host (reproducing device) receives the encoded media ID (MID) from the medium (memory card).

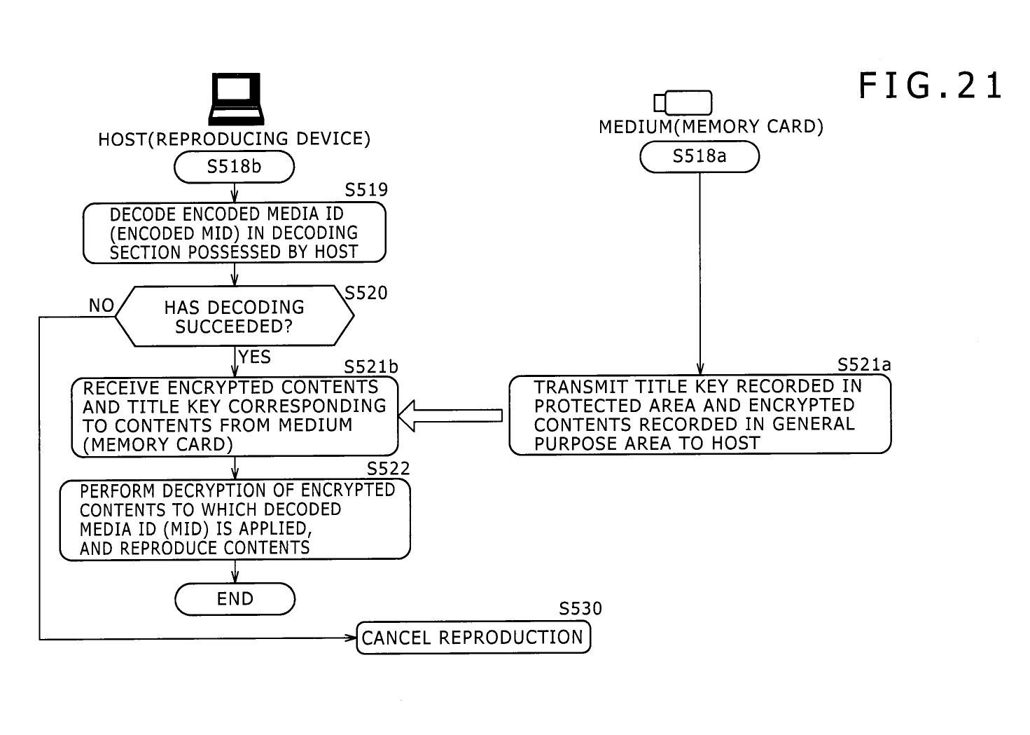

Next, the host (reproducing device) in step S519 shown in FIG. 21 decodes the encoded media ID (MID) by applying a decoding algorithm dedicated to the device which decoding algorithm can be performed by the device itself.

When it is determined in step S520 that the decoding has failed, the process proceeds to step S530 to stop the content reproducing process.

When it is determined in step S520 that the decoding has succeeded, and the media ID (MID) is obtained successfully, the process proceeds to steps S521a and S521b.

The medium (memory card) in step S521a provides data necessary for content reproduction.

That is, the medium (memory card) provides a title key stored in the protected area, encrypted contents stored in the general purpose area, and the like.

The host (reproducing device) in step S521b receives the title key, the encrypted contents, and the like from the medium (memory card).

Finally, the host (reproducing device) decrypts the encrypted contents using the title key received from the medium (memory card), and reproduces the contents.

Incidentally, though the processes of steps S518a and S518b to S522 are simplified in the present flow, these processes correspond to the processes described earlier with reference to FIG. 18, and processes such as a media ID MAC verification process, the obtainment of the title key by operation on a converted title key on the basis of usage control information, and the like are performed.

The medium (memory card) thus changes the mode of conversion of the media ID (MID) according to the host (reproducing device) for reproducing contents, and converts the media ID (MID).

This process allows the contents to be reproduced only when it is confirmed that the type of the host (reproducing device) matches the type information of the host certificate presented by the host (reproducing device).

In addition, the medium (memory card) can check the type of the host (reproducing device) on the basis of the host certificate (Host Cert), and control the use of contents according to the host (reproducing device).

For example, the use of contents can be controlled according to the type of the host (reproducing device) by allowing specific contents to be used by a recording and reproducing device only, and not allowing the specific contents to be used by a PC or a portable terminal.

Incidentally, in the flowcharts of FIGS. 19 to 21, as described with reference to FIGS. 9 to 11, a reproducing program corresponding to the type of selected contents is started in step S512, and a host certificate (Host Cert) associated with the reproducing program is selected (S513). However, as in the flow described with reference to FIGS. 12 to 14, the content reproducing program itself may select a host certificate according to a content type.

In addition, the following plurality of embodiments have been described above:
(First Embodiment) a process of selecting and starting a reproducing program according to a content type, and using a host certificate (Host Cert) associated with the started reproducing program;
(Second Embodiment) a process in which a reproducing program selects and uses a host certificate (Host Cert) according to a content type; and
(Third Embodiment) a process in which a mode of conversion of a media ID (MID) is changed according to the type of a host (reproducing device).

While these processes may each be performed singly, a combination of the first embodiment and the third embodiment or a combination of the second embodiment and the third embodiment may also be performed.

### 6. Example of Hardware Configuration of Each Device

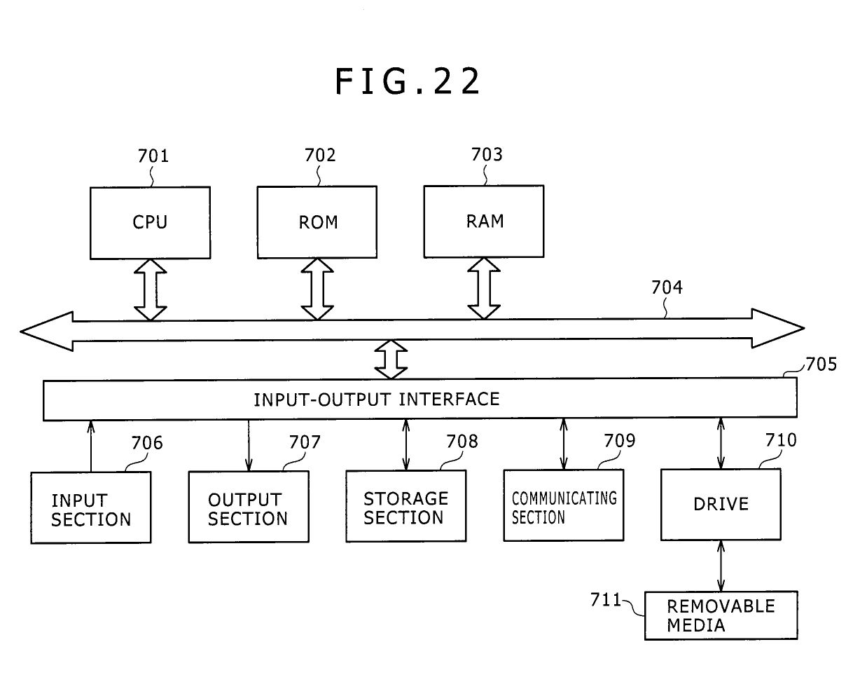

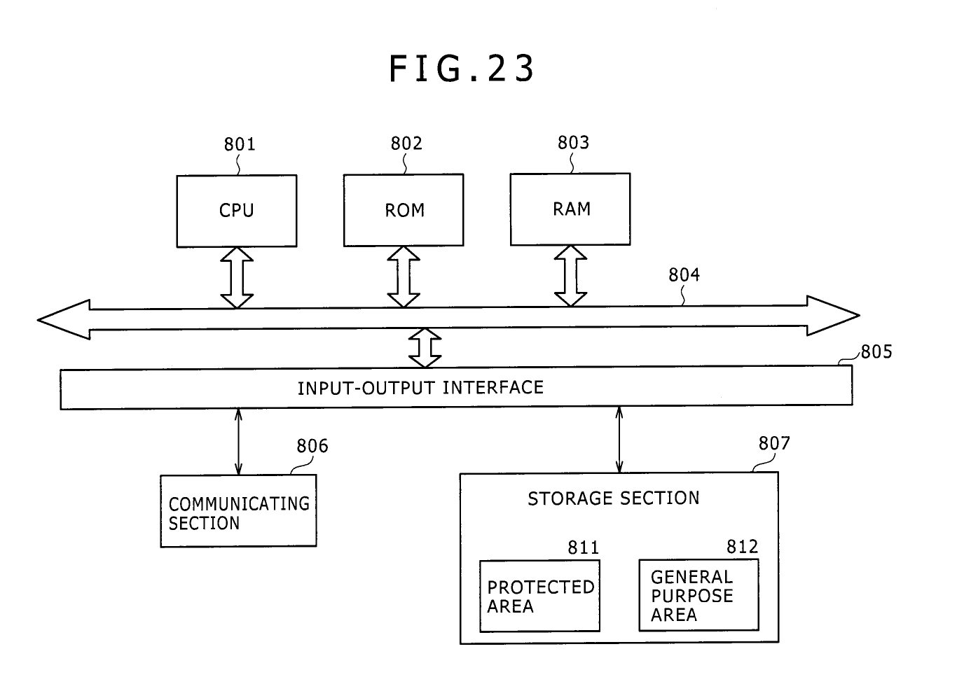

Finally, referring to FIG. 22 and FIG. 23, description will be made of an example of hardware configuration of each of the devices performing the above-described processes.

An example of hardware configuration of a host device that is loaded with a memory card and which records and reproduces data will first be described with reference to FIG. 22.

A CPU (Central Processing Unit) 701 functions as a data processing section configured to perform various kinds of processes according to a program stored in a ROM (Read Only Memory) 702 or a storage section 708. The CPU 701 for example receives contents from a broadcasting station or a server, records the received data onto a memory card (removable media 711 in FIG. 22), and reproduces data from the memory card (removable media 711 in FIG. 22). A RAM (Random Access Memory) 703 stores the program executed by the CPU 701, data, and the like as appropriate. The CPU 701, the ROM 702, and the RAM 703 are interconnected via a bus 704.

The CPU 701 is connected to an input-output interface 705 via the bus 704. The input-output interface 705 is connected with an input section 706 composed of various kinds of switches, a keyboard, a mouse, a microphone, and the like and an output section 707 composed of a display, a speaker, and the like. The CPU 701 performs various kinds of processes in response to a command input from the input section 706, and outputs results of the processes to the output section 707, for example.

The storage section 708 connected to the input-output interface 705 is for example formed by a hard disk or the like, and stores the program to be executed by the CPU 701 and various kinds of data. A communicating section 709 communicates with an external device via a network such as the Internet, a local area network, and the like.

A drive 710 connected to the input-output interface 705 drives removable media 711 such as a magnetic disk, an optical disk, a magneto-optical disk, a semiconductor memory such as a memory card, and the like, and obtains various kinds of data such as contents, key information, and the like recorded on the removable media 711. For example, using the obtained contents and key data, the contents are decrypted and reproduced according to a reproducing program executed by the CPU.

FIG. 23 shows an example of hardware configuration of a memory card. A CPU (Central Processing Unit) 801 functions as a data processing section configured to perform various kinds of processes according to a program stored in a ROM (Read Only Memory) 802 or a storage section 807. For example, the CPU 801 communicates with the server and the host device described in each of the foregoing embodiments, writes and reads data in the storage section 807, and determines whether access is possible or not in units of divided areas of a protected area 811 of the storage section 807. A RAM (Random Access Memory) 803 stores the program executed by the CPU 801, data, and the like as appropriate. The CPU 801, the ROM 802, and the RAM 803 are interconnected via a bus 804.

The CPU 801 is connected to an input-output interface 805 via the bus 804. The input-output interface 805 is connected with a communicating section 806 and the storage section 807.

The communicating section 806 connected to the input-output interface 805 communicates with a server or a host, for example. The storage section 807 is a data storage area. As described earlier, the storage section 807 has an access-limited protected area 811 and a general purpose area 812 in which data can be recorded and read freely.

Incidentally, the server can be implemented by a device having a similar hardware configuration to that of the host device shown in FIG. 22, for example.

### 7. Summary of Configurations according to Embodiments of Present Disclosure

Embodiments of the present disclosure have been explained above in detail with reference to specific embodiments thereof. It is obvious, however, that modifications and substitutions in the embodiments may be made by those skilled in the art without departing from the spirit of the present disclosure. That is, the present technology has been disclosed in a form that is illustrative and is not to be construed in a restrictive manner. In order to determine the spirit of the present disclosure, the section of claims is to be considered.

Incidentally, the technology disclosed in the present specification can also adopt the following constitutions.

(1) An information processing system including:
a medium for storing contents as an object of reproduction; and
a reproducing device configured to reproduce the contents stored on the medium;
wherein the reproducing device obtains a device certificate stored in a storage section and transmits the device certificate to the medium,
reproducing device type information indicating a device type of the reproducing device is recorded in the device certificate,
the medium encodes a media ID as information for identifying the medium according to an encoding algorithm selected according to the reproducing device type information recorded in the device certificate, and transmits the encoded media ID to the reproducing device, and
the reproducing device decodes the encoded media ID received from the medium according to a decoding algorithm corresponding to the device type of the reproducing device, and performs content decryption and reproduction involving data processing to which the obtained media ID is applied.

(2) The information processing system according to the above (1),
wherein the reproducing device decodes the encoded media ID received from the medium according to the decoding algorithm corresponding to the device type of the reproducing device, calculates a verification value based on the obtained media ID, performs a comparing and verifying process between the calculated verification value and a verification value for reference, the verification value for reference having been obtained from the medium, and decrypts and reproduces the contents stored on the medium on condition that verification is established.

(3) The information processing system according to the above (1) or (2),
wherein the reproducing device calculates the verification value based on the media ID by data processing to which a cryptographic key applied to decryption of encrypted contents stored on the medium is applied.

(4) The information processing system according to any one of the above (1) to (3),
wherein the medium stores a cryptographic key applied to decryption of the contents in a protected area allowed to be accessed on a basis of confirmation of an access right of the reproducing device, and the medium confirms the access right to the protected area storing the cryptographic key on a basis of protected area access right information recorded in the device certificate received from the reproducing device, and allows the cryptographic key to be read by the reproducing device when the access right of the reproducing device is confirmed.

(5) The information processing system according to any one of the above (1) to (4),
wherein the reproducing device transmits the obtained device certificate to the medium, and performs an authentication process, and

the medium determines whether to allow a cryptographic key reading request from the reproducing device on condition that the authentication process is established.

(6) A reproducing device configured to read and reproduce contents stored on a medium,
wherein a data processing section obtains a device certificate in which reproducing device type information indicating a device type of the reproducing device is recorded from a storage section, and transmits the obtained device certificate to the medium,
the data processing section receives an encoded media ID obtained by encoding a media ID as information for identifying the medium from the medium, decodes the received encoded media ID, and performs content decryption and reproduction involving data processing to which the obtained media ID is applied,
the encoded media ID is data encoded by the medium according to an encoding algorithm selected according to the reproducing device type information recorded in the device certificate, and
the data processing section decodes the encoded media ID according to a decoding algorithm corresponding to the device type of the reproducing device.

(7) The reproducing device according to the above (6),
wherein the data processing section decodes the encoded media ID received from the medium according to the decoding algorithm corresponding to the device type of the reproducing device, calculates a verification value based on the obtained media ID, performs a comparing and verifying process between the calculated verification value and a verification value for reference, the verification value for reference having been obtained from the medium, and decrypts and reproduces the contents stored on the medium on condition that verification is established.

(8) The reproducing device according to the above (6) or (7),
wherein the data processing section calculates a verification value based on the media ID by data processing to which a cryptographic key applied to decryption of encrypted contents stored on the medium is applied.

(9) The reproducing device according to any one of the above (6) to (8),
wherein the medium stores a cryptographic key applied to decryption of the contents in a protected area allowed to be accessed on a basis of confirmation of an access right of the reproducing device, and the data processing section supplies the device certificate in which information on an access right to the protected area is recorded to the medium, and reads the cryptographic key on condition that the access right to the protected area is confirmed by the medium.

(10) The reproducing device according to any one of the above (6) to (9),
wherein the data processing section transmits the device certificate to the medium, and performs an authentication process, and
the data processing section reads the cryptographic key applied to the decryption of the contents on condition that the authentication process is established with the medium.

(11) An information processing device including:
a storage section configure to store encrypted contents as an object of reproduction in a reproducing device and a cryptographic key to be applied to decryption of the encrypted contents; and
a data processing section;
wherein the data processing section receives a device certificate in which reproducing device type information indicating a device type of the reproducing device is recorded from the reproducing device, and
the data processing section generates an encoded media ID by encoding a media ID as information for identifying the information processing device according to an encoding algorithm selected according to the reproducing device type information recorded in the device certificate, and transmits the encoded media ID to the reproducing device.

(12) The information processing device according to the above (11),
wherein the data processing section transmits the encoded media ID and a verification value for reference, the verification value for reference having been generated on a basis of the media ID, to the reproducing device.

(13) The information processing device according to the above (11) or (12),
wherein the storage section has a protected area allowed to be accessed on a basis of confirmation of an access right of the reproducing device, and the cryptographic key is stored in the protected area, and
the data processing section confirms the access right to the protected area storing the cryptographic key on a basis of protected area access right information recorded in the device certificate received from the reproducing device, and allows the cryptographic key to be read by the reproducing device when the access right of the reproducing device is confirmed.

Methods of processes performed in the devices and the system described above and programs for making the processes performed are further included in constitutions according to embodiments of the present disclosure.

In addition, the series of processes described in the specification can be performed by hardware, software, or a composite configuration of both hardware and software. When processing is performed by software, a program in which a processing sequence is recorded can be executed after being installed into a memory within a computer incorporated in dedicated hardware, or executed after the program is installed on a general-purpose computer capable of performing various kinds of processing. For example, the program can be recorded on a recording medium in advance. In addition to being installed from a recording medium onto a computer, the program can be received via a network such as a LAN (Local Area Network), the Internet, and the like, and installed onto a recording medium such as a built-in hard disk or the like.

It is to be noted that the various processes described in the specification may be not only performed in time series according to the description but also performed in parallel or individually according to the processing power of a device performing the processes or a requirement. In addition, a system in the present specification is a logical set configuration of a plurality of devices, and is not limited to a system having devices of respective configurations within an identical casing.

As described above, according to the configuration of one embodiment of the present disclosure, a device or a method for controlling the use of contents according to the type of a reproducing device configured to reproduce the contents stored on a medium is realized.

Specifically, a device certificate in which the type of a reproducing device configured to reproduce contents stored on a medium, for example a device type indicating a reproduction only device such as a BD player, a PC, or the like, is recorded is provided from the reproducing device to the medium. The data processing section of the medium checks device type information recorded in the device certificate, encodes a media ID by selecting and applying a different encoding algorithm according to the device type, and then provides the encoded media ID to the reproducing device. The reproducing device decodes the encoded media ID by a decoding algorithm corresponding to the type of the device itself. Only when the decoding has succeeded, and the media ID can be obtained, the contents can be decrypted and reproduced. Content use control according to the type of the reproducing device is realized by these processes.

The present disclosure contains subject matter related to that disclosed in Japanese Priority Patent Application JP 2011-175608 filed in the Japan Patent Office on Aug. 11, 2011, the entire content of which is hereby incorporated by reference.

What is claimed is:

1. An information processing system comprising:
a medium for storing contents as an object of reproduction; and
a reproducing device configured to reproduce the contents stored on the medium, wherein
the reproducing device obtains a device certificate stored in a storage section and transmits the device certificate to the medium,
reproducing device type information indicating a device type of the reproducing device is recorded in the device certificate,
the medium encodes a media ID as information for identifying the medium according to an encoding algorithm selected according to the reproducing device type information recorded in the device certificate, and transmits the encoded media ID to the reproducing device, and
the reproducing device decodes the encoded media ID received from the medium according to a decoding algorithm corresponding to the device type of the reproducing device, and performs content decryption and reproduction involving data processing to which the obtained media ID is applied.

2. The information processing system according to claim 1, wherein the reproducing device decodes the encoded media ID received from the medium according to the decoding algorithm corresponding to the device type of the reproducing device, calculates a verification value based on the obtained media ID, performs a comparing and verifying process between the calculated verification value and a verification value for reference, the verification value for reference having been obtained from the medium, and decrypts and reproduces the contents stored on the medium on condition that verification is established.

3. The information processing system according to claim 2, wherein the reproducing device calculates the verification value based on the media ID by data processing to which a cryptographic key applied to decryption of encrypted contents stored on the medium is applied.

4. The information processing system according to claim 1, wherein
the medium stores a cryptographic key applied to decryption of the contents in a protected area allowed to be accessed on a basis of confirmation of an access right of the reproducing device, and
the medium confirms the access right to the protected area storing the cryptographic key on a basis of protected area access right information recorded in the device certificate received from the reproducing device, and allows the cryptographic key to be read by the reproducing device when the access right of the reproducing device is confirmed.

5. The information processing system according to claim 4, wherein
the reproducing device transmits the obtained device certificate to the medium, and performs an authentication process, and
the medium determines whether to allow a cryptographic key reading request from the reproducing device on condition that the authentication process is established.

6. A reproducing device configured to read and reproduce contents stored on a medium, wherein
a data processing section obtains a device certificate in which reproducing device type information indicating a device type of the reproducing device is recorded from a storage section, and transmits the obtained device certificate to the medium,
the data processing section receives an encoded media ID obtained by encoding a media ID as information for identifying the medium from the medium, decodes the received encoded media ID, and performs content decryption and reproduction involving data processing to which the obtained media ID is applied,
the encoded media ID is data encoded by the medium according to an encoding algorithm selected according to the reproducing device type information recorded in the device certificate, and
the data processing section decodes the encoded media ID according to a decoding algorithm corresponding to the device type of the reproducing device.

7. The reproducing device according to claim 6, wherein the data processing section decodes the encoded media ID received from the medium according to the decoding algorithm corresponding to the device type of the reproducing device, calculates a verification value based on the obtained media ID, performs a comparing and verifying process between the calculated verification value and a verification value for reference, the verification value for reference having been obtained from the medium, and decrypts and reproduces the contents stored on the medium on condition that verification is established.

8. The reproducing device according to claim 7, wherein the data processing section calculates a verification value based on the media ID by data processing to which a cryptographic key applied to decryption of encrypted contents stored on the medium is applied.

9. The reproducing device according to claim 6, wherein
the medium stores a cryptographic key applied to decryption of the contents in a protected area allowed to be accessed on a basis of confirmation of an access right of the reproducing device, and
the data processing section supplies the device certificate in which information on an access right to the protected area is recorded to the medium, and reads the cryptographic key on condition that the access right to the protected area is confirmed by the medium.

10. The reproducing device according to claim 6, wherein
the data processing section transmits the device certificate to the medium, and performs an authentication process, and
the data processing section reads the cryptographic key applied to the decryption of the contents on condition that the authentication process is established with the medium.

11. An information processing device comprising:
a storage section configured to store encrypted contents as an object of reproduction in a reproducing device and a cryptographic key to be applied to decryption of the encrypted contents; and
a data processing section, wherein
the data processing section receives a device certificate in which reproducing device type information indicating a device type of the reproducing device is recorded from the reproducing device, and
the data processing section generates an encoded media ID by encoding a media ID as information for identifying the information processing device according to an encoding algorithm selected according to the reproducing device type information recorded in the device certificate, and transmits the encoded media ID to the reproducing device.

12. The information processing device according to claim 11, wherein the data processing section transmits the encoded media ID and a verification value for reference, the verification value for reference having been generated on a basis of the media ID, to the reproducing device.

13. The information processing device according to claim 11, wherein
the storage section has a protected area allowed to be accessed on a basis of confirmation of an access right of the reproducing device, and the cryptographic key is stored in the protected area, and
the data processing section confirms the access right to the protected area storing the cryptographic key on a basis of protected area access right information recorded in the device certificate received from the reproducing device, and allows the cryptographic key to be read by the reproducing device when the access right of the reproducing device is confirmed.

14. An information processing method performed in an information processing system, the information processing system including a medium for storing contents as an object of reproduction and a reproducing device configured to reproduce the contents stored on the medium, the information processing method comprising:
the reproducing device obtaining a device certificate in which reproducing device type information indicating a device type of the reproducing device is recorded from a storage section and transmitting the device certificate to the medium;
the medium encoding a media ID as information for identifying the medium according to an encoding algorithm selected according to the reproducing device type information recorded in the device certificate, and transmitting the encoded media ID to the reproducing device; and
the reproducing device decoding the encoded media ID received from the medium according to a decoding algorithm corresponding to the device type of the reproducing device, and performing content decryption and reproduction involving data processing to which the obtained media ID is applied.

15. An information processing method for reading and reproducing contents stored on a medium in a reproducing device, the information processing method comprising:
a data processing section obtaining a device certificate in which reproducing device type information indicating a device type of the reproducing device is recorded from a storage section, and transmitting the obtained device certificate to the medium;
the data processing section receiving an encoded media ID obtained by encoding a media ID as information for identifying the medium from the medium, decoding the received encoded media ID, and performing content decryption and reproduction involving data processing to which the obtained media ID is applied,
the encoded media ID being data encoded by the medium according to an encoding algorithm selected according to the reproducing device type information recorded in the device certificate; and
the data processing section decoding the encoded media ID according to a decoding algorithm corresponding to the device type of the reproducing device.

16. An information processing method performed in an information processing device, the information processing device including a storage section configured to store encrypted contents as an object of reproduction in a reproducing device and a cryptographic key to be applied to decryption of the encrypted contents, and a data processing section, the information processing method comprising:
the data processing section receiving a device certificate in which reproducing device type information indicating a device type of the reproducing device is recorded from the reproducing device; and
the data processing section generating an encoded media ID by encoding a media ID as information for identifying the information processing device according to an encoding algorithm selected according to the reproducing device type information recorded in the device certificate, and transmitting the encoded media ID to the reproducing device.

17. A program for making a reproducing device read and reproduce contents stored on a medium, the program comprising:
making a data processing section obtain a device certificate in which reproducing device type information indicating a device type of the reproducing device is recorded from a storage section, and transmit the obtained device certificate to the medium;
making the data processing section receive an encoded media ID obtained by encoding a media ID as information for identifying the medium from the medium, decode the received encoded media ID, and perform content decryption and reproduction involving data processing to which the obtained media ID is applied,
the encoded media ID being data encoded by the medium according to an encoding algorithm selected according to the reproducing device type information recorded in the device certificate; and
making the data processing section decode the encoded media ID according to a decoding algorithm corresponding to the device type of the reproducing device.

18. A program for making an information processing device perform information processing, the information processing device including a storage section configured to store encrypted contents as an object of reproduction in a reproducing device and a cryptographic key to be applied to decryption of the encrypted contents, and a data processing section, the program comprising:
making the data processing section receive a device certificate in which reproducing device type information indicating a device type of the reproducing device is recorded from the reproducing device; and
making the data processing section generate an encoded media ID by encoding a media ID as information for identifying the information processing device according to an encoding algorithm selected according to the reproducing device type information recorded in the device certificate, and transmit the encoded media ID to the reproducing device.
